(19) United States
(12) Patent Application Publication
(10) Pub. No.: US 2008/0253360 A1
(43) Pub. Date: Oct. 16, 2008

(54) TERMINAL APPARATUS AND COMPUTER PROGRAM

(75) Inventor: Ryota NONAKA, Fukuoka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., OSAKA (JP)

(21) Appl. No.: 12/058,407

(22) Filed: Mar. 28, 2008

(30) Foreign Application Priority Data
Mar. 28, 2007 (JP) 2007 083757
Nov. 19, 2007 (JP) 2007 299020

(51) Int. Cl. H04L 12/66

(52) U.S. Cl. 370/352

(57) ABSTRACT

A terminal apparatus includes a communication unit connected to a private branch exchange and other terminal apparatus; a memory unit for storing address information for the other terminal apparatus; and a controller which, when receiving an incoming call command containing address information for the terminal apparatus as destination information from the private branch exchange via the communication unit, informs a user of the terminal apparatus of an incoming call addressed to the terminal apparatus, generates a substituted incoming call command in which the address information contained in the incoming call command is substituted with the address information for the other terminal apparatus stored in the memory unit, and transmits the substituted incoming call command to the other terminal apparatus via the communication unit so that the other terminal apparatus informs a user of the other terminal apparatus of the incoming call addressed to the terminal apparatus.

### BACKGROUND

The present invention relates to a terminal apparatus connected to an IP (Internet Protocol) network and a computer-readable medium recording a computer program that permits the terminal apparatus to operate a desired function.

In patent document 1, an example IP communication apparatus is described. According to this example, a handset or a headset having a microphone and a loudspeaker is provided for a PC (Personal Computer), and when the PC executes telephone function software, the PC serves as an IP phone. There is an example system equipped with a data center that includes a converter that converts identification data unique to the IP phone into an IP address. Further, an example communication system is described wherein a data center converts unique identification data into an IP address to be transmitted through a communication network.

[Patent Document 1] JP-A-2003-273900

Not only an IP phone, but also various other apparatuses are connected to the IP network. Further, from a viewpoint to obtain an effective function for establishing connections between telephones, performance of calling control via a telephone exchange is favorable for constructing a private switching network.

Therefore, the telephone exchange allocates extension numbers to the terminal apparatuses, such as the IP phones, and controls calling in order to identify the individual apparatuses. However, the quantity of extension numbers is limited. Further, the terminal apparatuses can be variously employed, i.e., in the conditions of that they can be connected to the IP network, or can be employed not only in the place where the telephone exchange is installed, but also at home or outside in the downtown to perform communication. Therefore, it is inconvenient to allocate the extension number to each of the terminal apparatuses, and a limited quantity of extension numbers would be occupied uselessly.

### SUMMARY

A main object of the present invention is to provide a terminal apparatus, to which a limited quantity of extension numbers can be allocated efficiency, and a computer-readable medium recording a computer program therefor.

According to the present invention, a terminal apparatus includes: a communication unit connected to a private branch exchange and other terminal apparatus; a memory unit for storing address information for the other terminal apparatus; and a controller which, when receiving an incoming call command containing address information for the terminal apparatus as destination information from the private branch exchange via the communication unit, informs a user of the terminal apparatus of an incoming call addressed to the terminal apparatus, generates a substituted incoming call command in which the address information contained in the incoming call command is substituted with the address information for the other terminal apparatus stored in the memory unit, and transmits the substituted incoming call command to the other terminal apparatus via the communication unit so that the other terminal apparatus informs a user of the other terminal apparatus of the incoming call addressed to the terminal apparatus.

According to the present invention, even when only one extension number is allocated to a terminal apparatus, a packet can be transmitted to one or more terminal apparatuses. Therefore, the limited number of extension numbers can be effectively allocated.

### BRIEF DESCRIPTION OF THE DRAWINGS

The above objects and advantages will become more apparent by describing in detail preferred exemplary embodiments thereof with reference to the accompanying drawings, wherein like reference numerals designate like or corresponding parts throughout the several views, and wherein:

FIG. 1 is a diagram showing the general configuration of an IP communication system according to a first embodiment;

FIG. 2 is a diagram for explaining the arrangement of a terminal apparatus;

FIG. 3 is a diagram for explaining the structure of setup data managed by a PBX (Private Branch exchange);

FIG. 4 is a diagram for explaining the structure of setup data managed by a primary IP terminal;

FIGS. 5A and 5B are diagrams for explaining the structure of setup data managed by a secondary IP terminal;

FIG. 6 is a diagram for explaining the incoming-call operation of the IP communication system;

FIG. 7 is a flowchart showing the processing for shifting the primary IP terminal from the call waiting state to an incoming-call state and to an outgoing call prohibited state;

FIG. 8 is a flowchart showing the processing for shifting the secondary IP terminal from the call waiting state to an incoming-call state, to the calling state and to an outgoing call prohibited state;

FIG. 9 is a flowchart for explaining the outgoing call prohibited state of the primary IP terminal;

FIG. 10 is a flowchart for explaining the operation performed in the calling state of the secondary IP terminal;

FIG. 11 is a flowchart showing the processing for shifting the secondary IP terminal from the calling state to the call waiting state;

FIG. 12 is a flowchart showing the processing for shifting the primary IP terminal from the outgoing call prohibited state to the call waiting state;

FIG. 13 is a diagram for explaining the outgoing call operation of the IP communication system;

FIG. 14 is a flowchart showing the processing for shifting the primary IP terminal from the call waiting state to the outgoing call prohibited state;

FIG. 15 is a flowchart showing the processing for shifting the secondary IP from the call waiting state to the outgoing calling state, to the calling state and to the outgoing call prohibited state;

FIG. 16 is a diagram for explaining the outgoing call operation of an IP communication system according to a second embodiment;

FIG. 17 is a flowchart for explaining the operation of the primary IP terminal in the broadcasting state; and

FIG. 18 is a flowchart for explaining the operation of the secondary IP terminal in the broadcasting state.

### DETAILED DESCRIPTION

### First Embodiment

### System Configuration

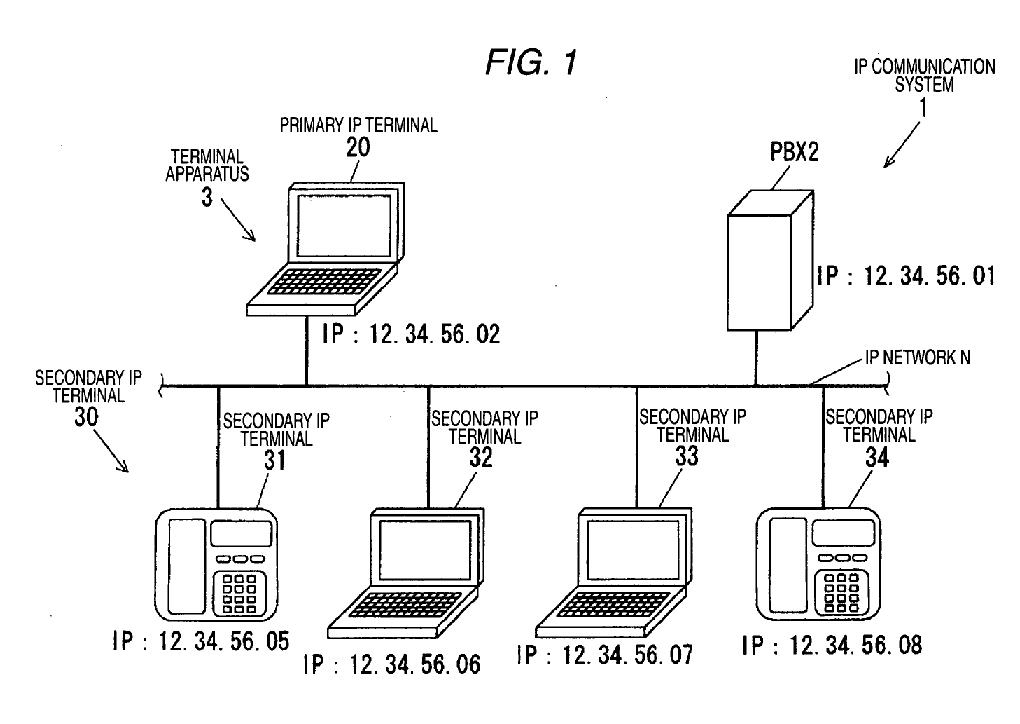

An IP communication system according to one embodiment of the present invention will now be described while referring to the accompanying drawings. FIG. 1 is a diagram showing the general configuration of the IP communication system of this embodiment. In FIG. 1, an IP communication system 1 is provided by connecting, to an IP network N, various apparatuses that will be described later in detail. The IP network N is generally called a LAN (Local Area Network), and various standards and methods are proposed and employed for a LAN type, such as the configuration or either the wire or wireless type. Since the detailed contents of the LAN are not the subject of the present invention, hereinafter in this invention, a network via which the IP communication system performs communication by exchanging a packet based on the TCP/IP protocol is generally called an IP network.

A Private Branch eXchange (PBX) 2 is compatible with two exchange types: a time-dividing exchange function, which is a conventional function for connecting or switching between telephones and the above described packet exchange function. Especially, the PBX 2 includes an interface with the IP network N to perform the packet exchange function.

A terminal apparatus 3 includes an interface with the IP network N, and is operated by mounting software in order to serve as an IP phone. A plurality of terminal apparatuses 3 may be connected. In the configuration of the IP communication system 1, the terminal apparatus 3 that corresponds to the upper concept rank is called a primary IP terminal 20, for the sake of convenience. For the PBX 2, this terminal 3 is regarded as a terminal apparatus to which one extension number is allocated.

Further, for the sake of convenience, the terminal apparatuses 3 that correspond to the lower concept rank in the configuration of the IP communication system 1 are called IP terminals 30 (31 to 34). For the PBX 2, these terminals are regarded as secondary IP terminals 30 extended from the primary IP terminal 20.

In the example shown in FIG. 1, one primary IP terminal 20 is connected to the IP network N, and four secondary IP terminals 30 are connected.

However, one, or four or more terminals for the secondary IP terminal 30 may be connected. Furthermore, as another system configuration, the PBX 2, the primary IP terminal 20 and the secondary IP terminal 30 may be connected to the IP network N via a network connection device, such as a hub. Similarly, the secondary IP terminals 30 may be connected via a router, or may be located in the same segment to the PBX 2 and the primary IP terminal 20.

As an example for the primary IP terminal 20 of this embodiment, an interface to the IP network N is provided for a computer (a notebook PC (Personal Computer) in the example in FIG. 1) and the computer identifies an IP address, and also a microphone and loudspeakers are equipped. Further, the telephone software is installed in the computer, and by executing this software, the computer is set to serve as the primary IP terminal 20. In this manner, the computer (IP software telephone) that functions as the terminal apparatus 3 is provided.

As an example secondary terminal 30 of this embodiment, a desktop IP phone is employed for the secondary IP terminals 31 and 34. The external appearance of the IP phone is a common telephone that includes a handset and a numeric keypad; however, a control circuit and software incorporated include an interface with the IP network N, so that an IP address can be identified by the IP phone and thus an IP phone function can be provided.

As another example secondary terminal 30, an IP software telephone is employed for the IP terminals 32 and 33. The secondary IP terminals 32 and 33 are IP software telephone, like the primary terminal 20. Since the telephone software is set up, these terminals can serve as the secondary IP terminals 32 and 33.

[Terminal Apparatus]

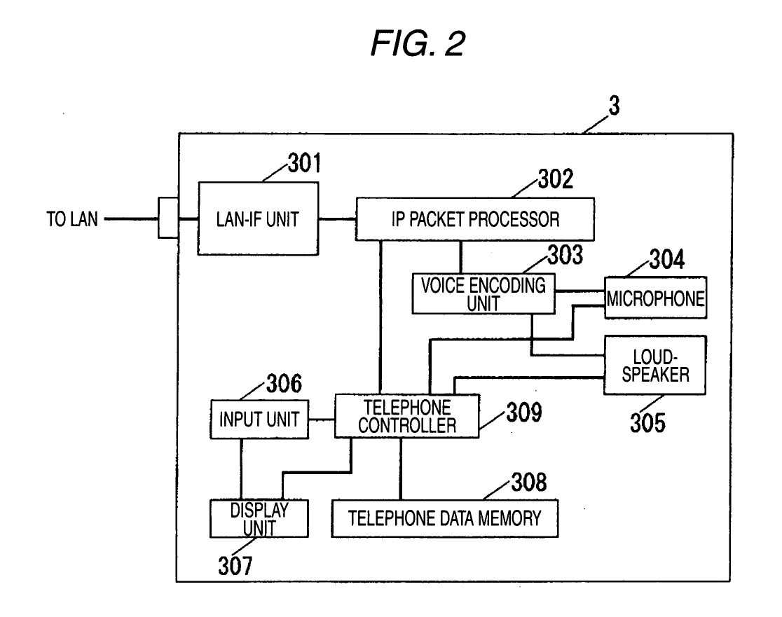

While referring to FIG. 2, the arrangement of the terminal apparatus 3 will now be described in detail by referring to an example wherein a computer is employed as the terminal apparatus 3. FIG. 2 is a diagram for explaining the arrangement of the terminal apparatus 3. The terminal apparatus 3 includes a LAN-IF unit 301, which is a communication unit for performing communication via the IP network N and also is a network IF (interface) for accessing the IP network N. The terminal apparatus 3 also includes an IP packet processor 302, a voice encoding unit 303, a microphone 304, loudspeakers 305, an input unit 306, a display unit 307, a telephone data memory 308 and a telephone controller 309.

When a packet is transmitted, the IP packet processor 302 generates a packet format that is compatible with the IP network N. Further, the transmission destination address and data to be transmitted, which constitute a packet to be transmitted. The IP packet receives an instruction controlled by the telephone controller 309. The processor 302 also identifies a destination address of a received packet, determines whether the received packet is for the own terminal apparatus 3 (self-terminal apparatus), extracts data from the received packet, and outputs audio data or control data.

The voice encoding unit 303 converts the audio data extracted by the IP packet processor 302 into an audio signal, and outputs the audio signal to the loudspeakers 305. The voice encoding unit 303 also converts an audio signal received from the microphone 304 into audio data, and outputs the audio data to the IP packet processor 302. The microphone 304 and the loudspeakers 305 are mounted to the terminal apparatuses 3 (the primary terminal 20 and the secondary IP terminals 32 and 33) individually, or integrally as a headset.

When the terminal apparatus 3 is constituted as a telephone terminal, the microphone 304 and the loudspeakers 305 are provided together as a handset for the secondary IP terminals 32 and 33 (see FIG. 1), and an on-hook switch is equipped to detect that the handset is placed on the terminal apparatus. The on-hook switch is included as one part of the input unit 306, and a detection signal of the on-hook switch is output from the input unit 306 to the telephone controller 309 that will be described later.

The input unit 306 includes a numeric keypad, a keyboard and a pointing device, such as an external mouse, connected to the terminal apparatus 3, to transmit numbers and characters to the terminal apparatus 3.

The display unit 307 includes an LCD (Liquid Crystal Display) panel. When a computer is employed as the terminal apparatus 3, a CRT (Cathode Ray Tube) may be externally connected to be used as a display unit 307.

The telephone data memory 308 is a terminal memory of the terminal apparatus 3 in which telephone function software and various setup data are stored. An IP address that will be described later is also stored in the telephone data memory 308.

The telephone controller 309 is a terminal control unit for the terminal apparatus 3 to execute the telephone function software. This telephone controller 309 totally controls the IP software telephone.

The telephone function software is provided by a software package, such as a CD-ROM (Compact Disc Read-Only Memory), a DVD (Digital Versatile Disk) or a flexible disk. The software package is a set of computer programs that permits a general-purpose computer to serve as an IP software telephone. The telephone function software is read by a reproduction apparatus, and is installed in the telephone data memory 308. Alternatively, the telephone function software may be downloaded through the LAN-IF unit 301 from a server connected to the IP network N, and be installed.

When the general-purpose computer performs the computer program of this invention in this manner, the computer can be provided as an IP software telephone, and as a terminal apparatus according to this invention. As a result, the general-purpose computer can act as the terminal apparatus of the invention to perform the control processing.

[Address Setup]

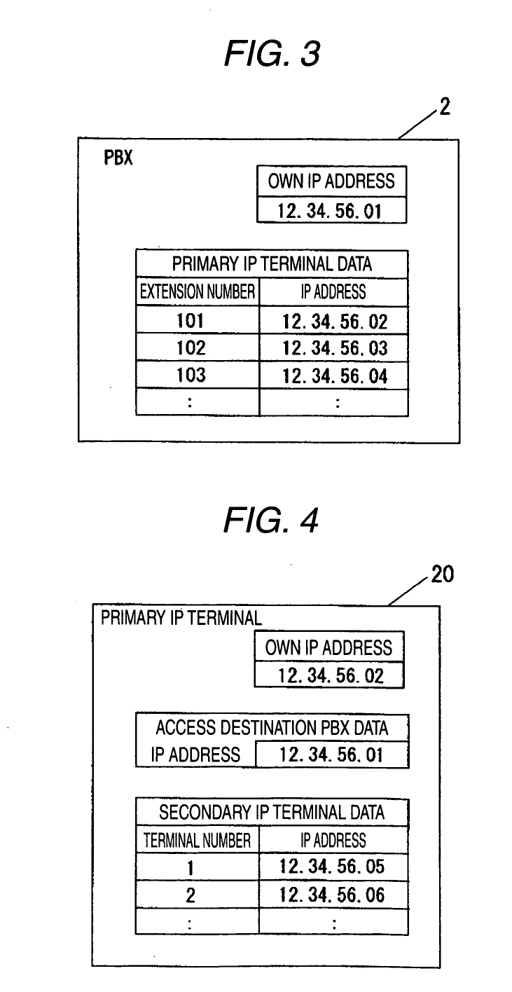

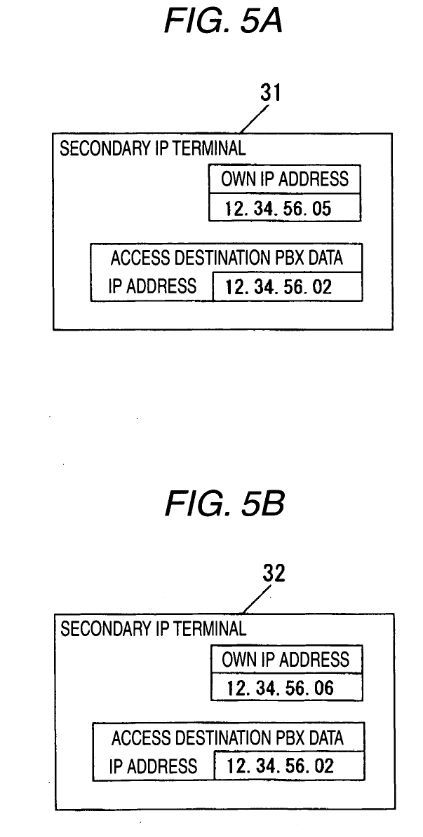

While referring to FIGS. 3 to 5, an explanation will now be given for data used to set IP addresses allocated to the individual terminal apparatuses that are connected to the IP network N. The setup data indicate the contents of IP addresses stored in the telephone data memory 308. FIG. 3 is a diagram for explaining the structure of setup data managed by the PBX. FIG. 4 is a diagram for explaining the structure of setup data managed by the primary IP terminal 20. FIGS. 5A and 5B are diagrams for explaining the structures of setup data respectively managed by the secondary IP terminals 31 and 32.

The IP addresses of the individual terminal apparatuses 3 are allocated when the IP communication system 1 is constructed. For example, referring to FIG. 1, IP addresses “12.34.56.01” for the PBX 2, “12.34.56.02” for the primary IP terminal 20 and “12.34.56.05 to 08” for the secondary IP terminals 31 to 34 are stored as setup data in the memory of the PBX 2 and in the telephone data memory 308 of the terminal apparatus 3.

Shown in FIGS. 3 to 5 are the states wherein the IP addresses are stored in the memory of the PBX 2 and the telephone data memory 308 of the terminal apparatuses 3. In FIG. 3, the setup data in the memory of the PBX 2 includes IP address “12.34.56.01” of the PBX 2 itself. Further, the IP addresses of the primary IP terminals 20 that belong to the IP communication system 1 are designated, and are registered in correlation with the extension numbers of the primary IP terminals 20. For example, in this embodiment, extension number “101” is allocated to the primary IP terminal 20 in FIG. 1, and in FIG. 3, IP address “12.34.56.02” of the primary IP terminal 20 is registered in consonance with extension number “101”. Similarly, for another primary IP terminal, IP address “12.34.56.03” is correlated in consonance with extension number “102”.

In FIG. 4, for the primary IP terminal 20, its IP address “12.34.56.02” is designated and registered as the setup data. Further, destination IP addresses of the other terminal apparatuses that belong to the IP communication system 1 are also designated and registered. For example, in this embodiment, referring to FIG. 4, IP address “12.34.56.01” of the PBX 2 at a connection destination and the IP address of the secondary IP terminal 30 are designated and registered. As for the IP addresses of the secondary IP terminals 30, IP address “12.34.56.05” of the secondary IP terminal 31 is registered as terminal number 1, and IP address “12.34.56.06” of the secondary IP terminal 32 is registered as terminal number 2. In the same manner, the IP addresses of the other secondary IP terminals 33 and 34 are registered.

In FIG. 5A, IP address “12.34.56.05” of the secondary IP terminal 31 is designated and registered as setup data of the secondary IP terminal 31. Further, IP address “12.34.56.02” of the primary IP terminal 20 is designated and registered as the IP address of the PBX 2 that is a connection destination. For this setup, as a connection destination for the secondary IP terminals 30, the IP address of the PBX 2 is replaced with the IP address “12.23.56.02” of the primary IP terminal 20, which is then stored. That is, the IP address of the primary IP terminal 20 is designated, instead of the IP address of the PBX 2. This is because the individual secondary IP terminals 30 is to perform communication with the PBX 2 via the primary IP terminal 20.

Likewise, in FIG. 5B, IP address “12.34.56.06” of the secondary IP terminal 32 is designated and registered as setup data for the secondary IP terminal 32. Further, the IP address “12.34.56.02” of the primary IP terminal 20 is designated and registered as the IP address of the PBX 2 that is a connection destination.

Since a conventional IP phone generally belongs to the PBX 2, the IP phone includes an area in which the IP address of the PBX 2 is to be stored as a connection destination address to directly communicate with the PBX 2. On the other hand, the secondary IP terminal 30 of this embodiment includes, in setup data, the IP address of the primary IP terminal 20, instead of the IP address of the PBX 2 that is a connection destination. Since in this manner the IP address of the primary IP terminal 20 is designated in the address setup area that is already prepared, the number of entries for setup data need not be increased (accordingly, the memory capacity need not be increased), and the IP phone can be used as the secondary IP terminal 30 for the embodiment.

Furthermore, since the addresses of the primary IP terminal 20 and the secondary IP terminals 30 are so designated that the above described relationship is established, the following effects can be obtained. Considering the IP communication system 1 on the viewpoint from the PBX 2 based on an IP address, the primary IP terminals 20 are regarded as one of a plurality of extension terminal apparatuses. On the other hand, considering the IP communication system 1 on the viewpoint from the primary IP terminal 20 based on an IP address, the primary IP terminal 20 is regarded as one of extension terminal apparatuses connected to the PBX 2. Further, the primary IP terminal 20 is regarded as a PBX 2 relative to a plurality of secondary IP terminals 30. In addition, considering the IP communication system 1 on the viewpoint from the secondary IP terminal 30 based on an IP address, the primary IP terminal 20 is regarded as a PBX 2.

With this arrangement, even when only one extension number is allocated to the terminal apparatus 3, an incoming call for a specific terminal apparatus can be transmitted as a packet to the other, one or more terminal apparatuses 3 (secondary IP terminal apparatuses 30). Further, even when one or more of the other terminal apparatuses 3 are moved to a place accessible to the IP network N, the terminal apparatus 3 can receive a packet from the PBX 2 via the IP network N according to this invention. Therefore, the limited number of extension numbers can be efficiently allocated.

[Incoming-Call Operation]

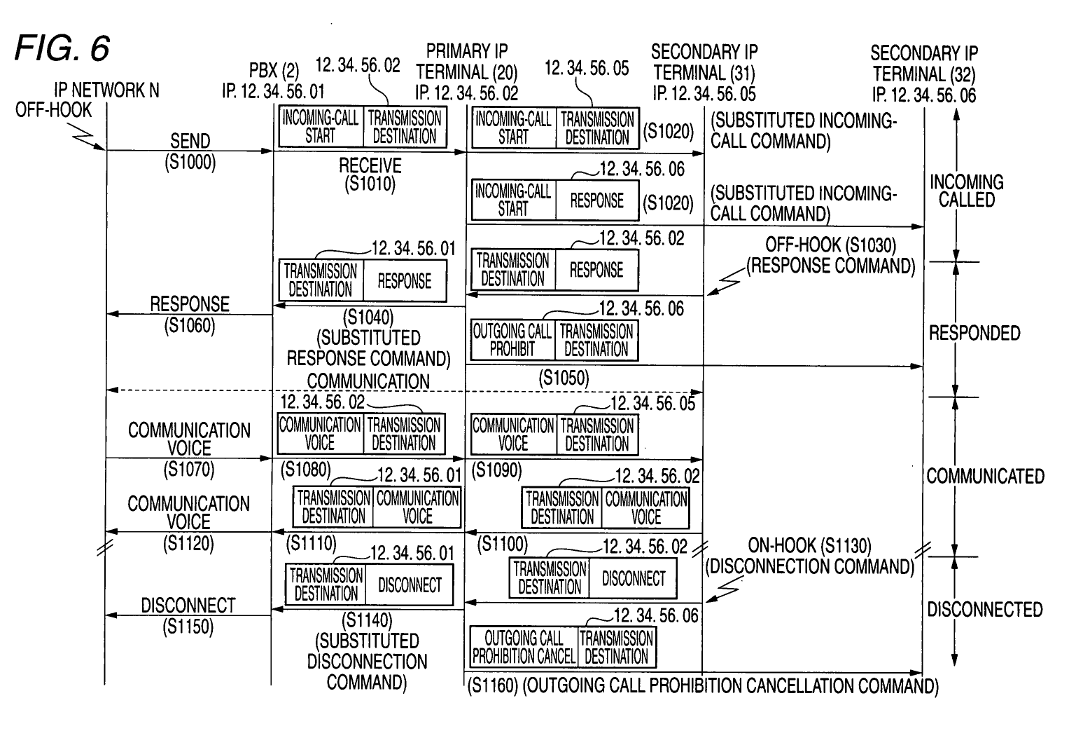

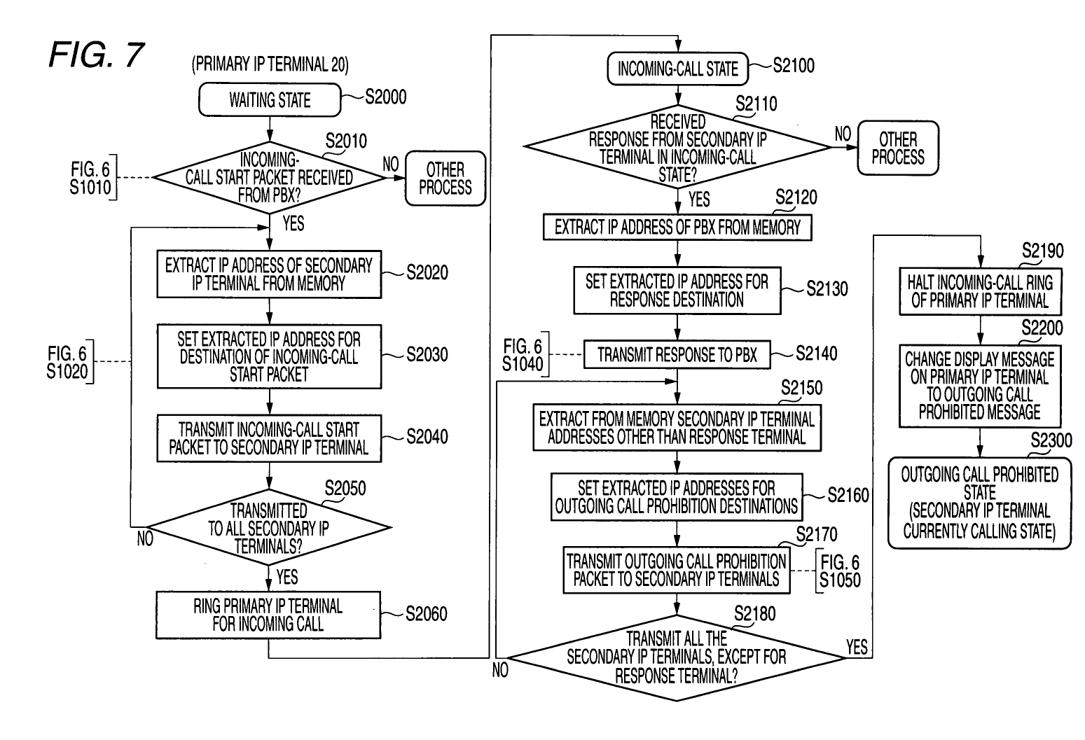

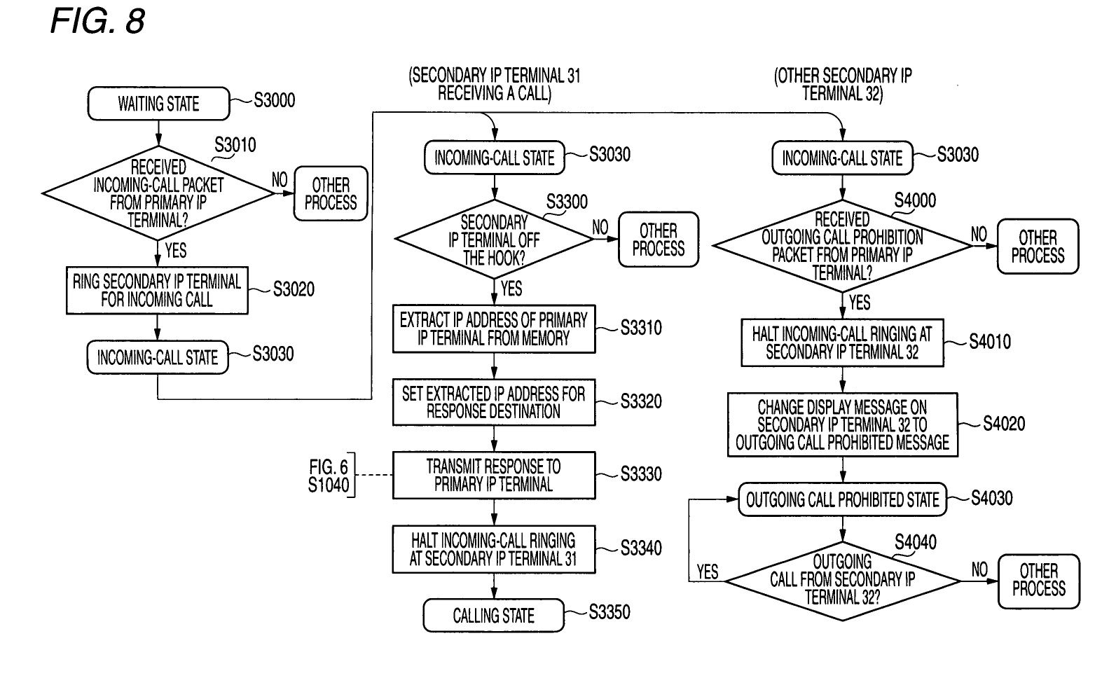

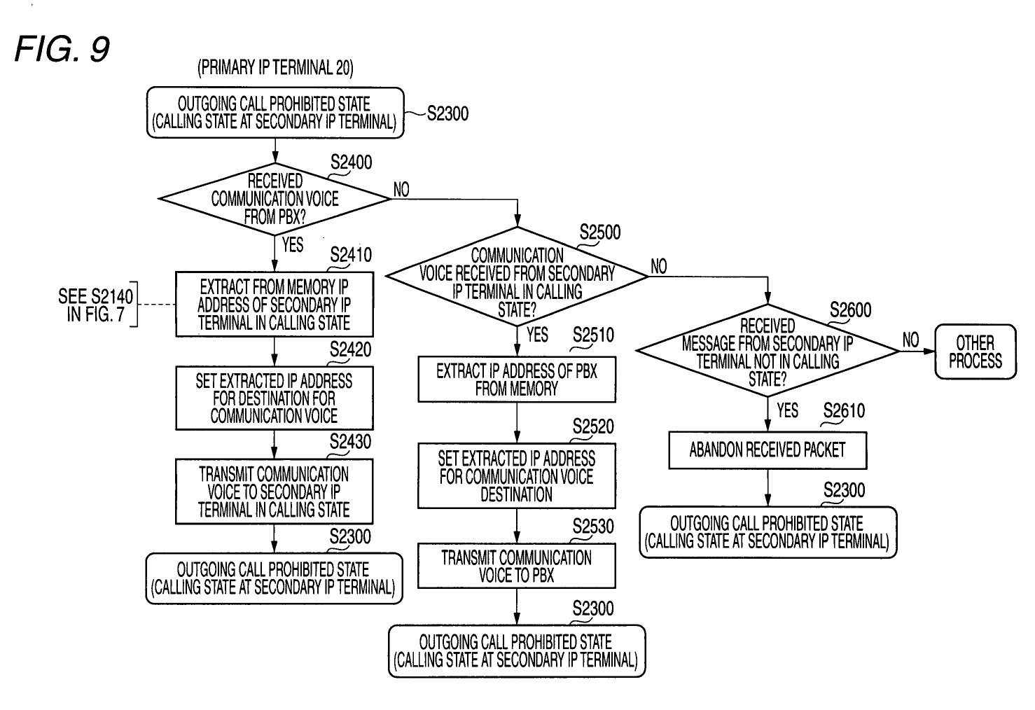

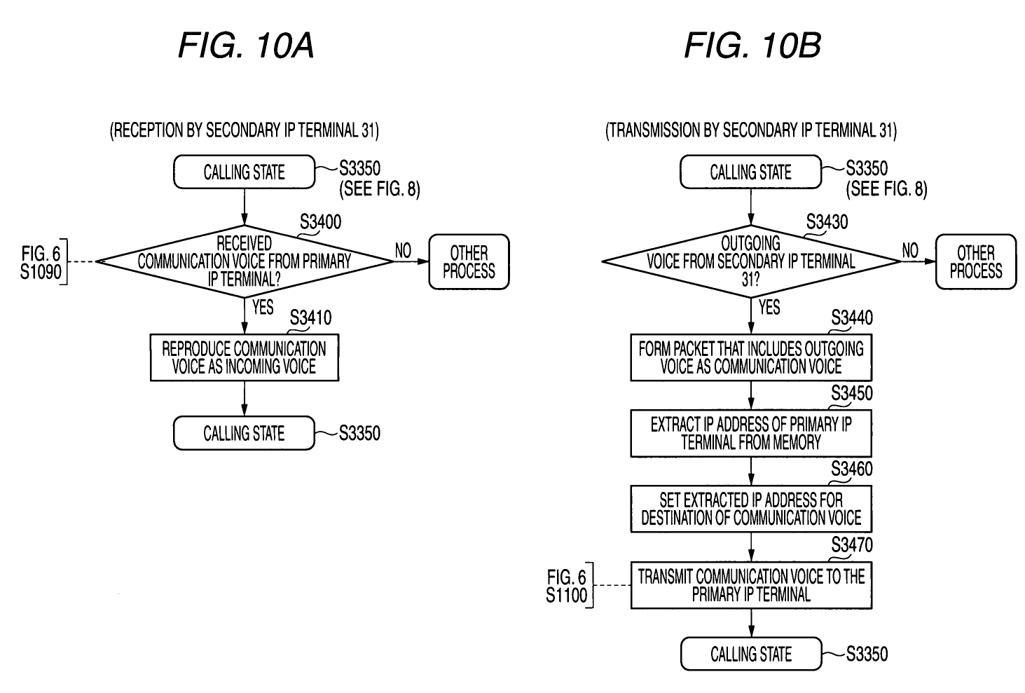

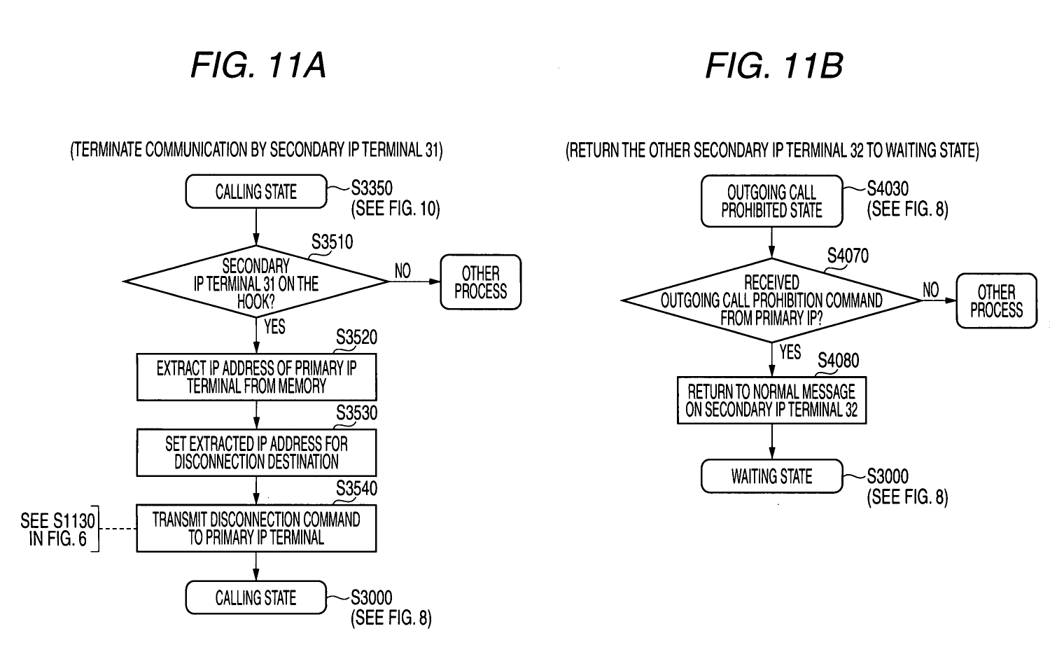

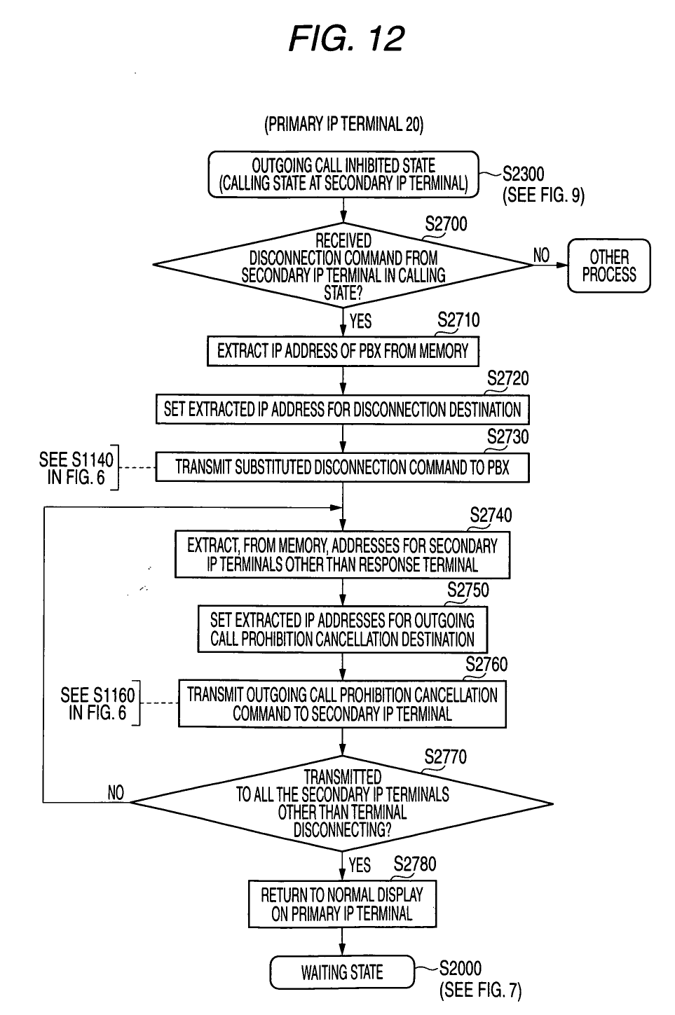

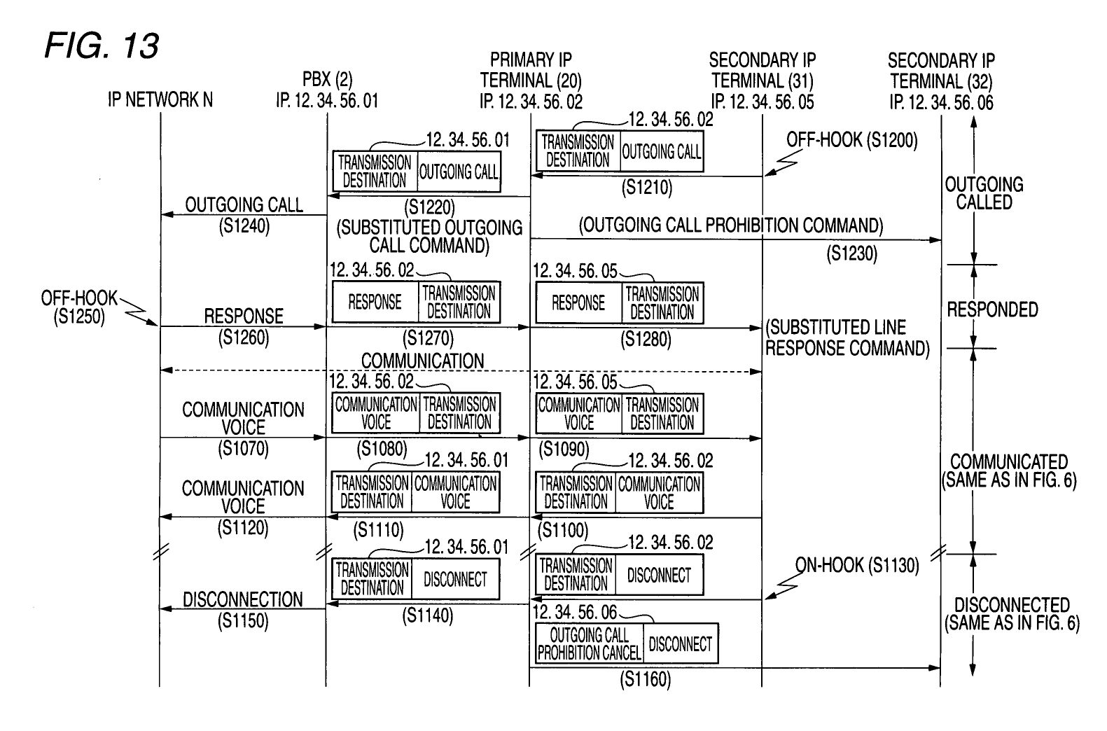

The incoming-call operation of the IP communication system 1 of this embodiment having the above configuration will now be described. FIG. 6 is a diagram for explaining the incoming-call operation of the IP communication system 1. For simplifying the description, two secondary IP terminals 30 (the secondary IP terminals 31 and 32) are employed for FIG. 6.

Referring to FIG. 6 and FIGS. 1, 3 and 4, assume that a call has arrived at extension number “101” of the PBX 2 via the IP network N (S1000).

The PBX 2 examines the setup data stored in the memory of the PBX 2, and extracts IP address “12.34.56.02” correlated with extension number “101”. Then, based on a command (incoming-call command) indicating that a call arrived, the PBX 2 generates a packet to be transmitted to the IP network N. This packet represents an incoming-call start, and includes IP address “12.34.56.02”, which is extracted from the memory as a transmission destination address. Then, the PBX 2 transmits the incoming-call start packet to the primary IP terminal 20, whose extension number is “101” and the IP address is “12.34.56.02” (S1010).

In FIG. 6, the image of a packet is also shown together with indication of step S1010. Further, the IP address correlated with a “transmission destination” of the packet is also shown with the packet image. Hereinafter, “incoming-call start” represents the contents of a packet, and corresponds to the contents of a data portion of a packet. Similarly, “response,” “outgoing call prohibition,” “communication voice” and “disconnection” also represent the contents of a packet.

Further, in this invention, a “transmission destination” represents a packet destination, and corresponds to the contents of the header of a packet. The header of the packet includes a destination, a transmission source and the other relevant information. Therefore, information included in the header related to the destination is especially called destination information. Furthermore, information related to an address, regardless of a destination or a transmission source, is called address information.

Moreover, according to this invention, a command instructs the processing function of a computer system, regardless of via a network or a line. In addition, a packet is expressed as a unit for communication used to exchange an instruction or data. In other words, a function that is the content for communication is called a command, while a set of data to be exchanged through communication is called a packet.

[Substituted Incoming-Call Command]

The primary IP terminal 20, which is waiting for the arrival of an incoming-call start packet, receives this incoming-call start packet. Then, the primary IP terminal 20 substitutes information indicating the destination of the incoming-call packet that has been received, i.e., transmission destination address, with the IP address of the secondary IP terminals 31 and 32, and generates a substituted incoming-call packet, i.e., a substituted incoming-call command. Then, the primary IP terminal 20 transmits the substituted incoming-call packet to the secondary IP terminals 31 and 32, and is shifted to the incoming-call state (S1020).

The operation for shifting the primary IP terminal 20 from the call waiting state to the incoming-call state will be described in detail while referring to FIG. 7. FIG. 7 is a flowchart showing the processing in which the primary IP terminal 20 is shifted from the call waiting state to the incoming-call state and to the outgoing call prohibited state.

In FIG. 7, the primary IP terminal 20 is initially in the call waiting state (S2000). In the call waiting state, the primary IP terminal 20 waits for reception of an incoming-call start packet from the PBX 2. When such a packet is not received, the primary IP terminal 20 performs the other process (S2010).

The process at S2010 for determining whether the primary IP terminal 20 receives an incoming-call packet at S2010 is performed as follows. First, the LAN-IF unit 301 receives a packet. Then, the IP packet processor 302 extracts data from the received packet, and outputs the data to the telephone controller 309 (see S1010 in FIG. 6). Assume that the primary IP terminal 20 receives a packet at S1010. At this time, the destination address of the received packet is (IP: 12.34.56.02) of the primary IP terminal 20, and the transmission source information is (IP: 12.34.56.01) of the PBX 2. Thus, the telephone controller 309 determines that the primary IP terminal 20 has received the incoming-call start packet from the PBX 2.

The telephone controller 309 extracts the IP addresses of the secondary IP terminals 30 from the telephone data memory 309 (S2020). The telephone controller 309 transmits an instruction to the IP packet processor 302 to designate the extracted IP addresses of the secondary IP terminals 30 (e.g., “12.34.56.05” for the secondary IP terminal 31 and “12.34.56.06” for the secondary IP terminal 32) to be the transmission destination addresses for the incoming-call start packet (S2030). That is, a substituted incoming-call command is generated. Then, packets for the substituted incoming-call command are transmitted from the LAN-IF unit 301 via the IP network N to the individual secondary IP terminals 30 (S2040).

As for a packet to be transmitted from the primary IP terminal 20 to the secondary IP terminals 30, destinations addresses are (IP: 12.34.56.05 to 08), and the transmission source information is substituted with the IP address (12.34.56.02) of the primary IP terminal 20.

In this manner, the incoming-call start packet is transmitted while the destination address is changed to the address of each secondary IP terminal 30. The telephone controller 309 determines whether the packet has been transmitted to all the IP addresses of the secondary IP terminals 30 stored in the telephone data memory 308, and when the packet is not yet transmitted, the processing beginning at S2020 is repeated (S2050).

When the packet has been transmitted to all the secondary IP terminals 30, the telephone controller 309 of the primary IP terminal 20 generates rings through the loudspeakers 305 of the terminal apparatus 3 to notify the user of the terminal apparatus 3 of an incoming call (S2060). Then, the telephone controller 309 is shifted to the incoming-call state (S2100).

With this arrangement, even when only one extension number is allocated to the terminal apparatus, an incoming-call command received by a specific terminal apparatus can be transmitted to the other terminal apparatuses. Further, the user of the terminal apparatus can be notified of the arrival of a call, and also the users of the other terminal apparatuses can be notified of that effect. Therefore, when a terminal apparatus is moved to a place accessible to the IP network, the terminal apparatus can receive a packet from the other terminal apparatus through the PBX. Further, the limited number of extension numbers can be effectively allocated, so that a profitable IP communication system can be provided.

[Incoming-Call State]

Sequentially, the operation in which the secondary IP terminal 30 receives a call in a period during which the primary IP terminal 20 is shifted to the incoming-call state. Assume that the secondary IP terminal 31 in FIG. 6 is to answer an incoming call. FIG. 8 is a flowchart showing the processing for shifting the secondary IP terminal from the call waiting state to the incoming-call state, to the calling state and to the outgoing call prohibited state.

In FIG. 8, the secondary IP terminal 31 is in the call waiting state (S3000). In the call waiting state, the secondary IP terminal 31 is waiting for reception of an incoming-call start packet (substituted incoming-call command) from the primary IP terminal 20. When such a packet is not received, the secondary IP terminal 31 performs the other process (S3010).

The processing at S3010 for determining whether the secondary IP terminal 31 receives the incoming-call start packet is performed as follows. First, the LAN-IF unit 301 receives an incoming-call start packet (substituted incoming-call command) (see S1020 in FIG. 6). The IP packet processor 302 extracts data from the received packet, and outputs the data to the telephone controller 309. At this time, the destination address of the received packet is (IP: 12.34.56.05) of the secondary IP terminal 31, and the transmission source information is (IP: 12.34.56.02) of the primary IP terminal 20. Thus, the telephone controller 309 determines that the secondary IP terminal 31 has received an incoming-call start packet from the primary IP terminal 20.

When the telephone controller 309 of the secondary IP terminal 31 determines that an incoming-call start packet is received from the primary IP terminal 20, the telephone controller 309 generates rings through the loudspeakers 305 to notify the user of the secondary IP terminal 31 of an incoming call (S3020). The secondary IP terminal 31 is shifted to the incoming-call state (see S1030 in FIG. 6 and S3030 in FIG. 8).

[Calling State]

Following this, the operation in which the secondary IP terminal 31 in the incoming-call state is shifted to the calling state will be described. As explained at S1020 in FIG. 6 and at S2020 to S2050 in FIG. 7, the individual secondary IP terminals (31 to 34) are ringing through the loudspeakers 305 to notify their users of incoming calls. That is, the secondary IP terminals 31 to 34 are currently in the incoming-call state.

Assume that the user of the secondary IP terminal 31 raises the handset to respond to the notification of an incoming call. Following S3030 in FIG. 8, the telephone controller 309 of the secondary IP terminal 31 determines whether the off-hook state is established by the user. When the off-hook state is not established, the other process is performed (S3300; see S1030 in FIG. 6).

When the off-hook state is detected, the telephone controller 309 extracts the IP address of the primary IP terminal 20 from the telephone data memory 308 (S3310). In this embodiment, referring to FIGS. 5 and 6, the IP address of the connection destination PBX is stored in the telephone data memory 308 of the secondary IP terminal 31. However, since the address of the primary IP terminal 20 is actually entered as address data, the telephone controller 309 of the secondary IP terminal 31 regards the secondary IP terminal 31 itself as the extension terminal connected to the PBX, and behaves as the secondary IP terminal 31 relative to the primary IP terminal 20.

The telephone controller 309 transmits an instruction to the IP packet processor 302 to designate the extracted IP address of the primary IP terminal 20 to be the transmission destination address of a response packet (response command) to the incoming-call start packet (S3320).

The secondary IP terminal 31 transmits the response packet to the primary IP terminal 20 via the LAN-IF unit 301 (S3330; see S1040 in FIG. 6). That is, this response command represents a reply to the substituted incoming-call command. Then, the secondary IP terminal 31 halts ringing through the loudspeakers 305 to notify the user of an incoming call (S3340), and is shifted to the calling state (S3350).

Through this processing, the response packet (response command) shown in FIG. 6 (S1030) is transmitted from the secondary IP terminal 31 to the primary IP terminal 20.

[Substituted Response Command]

The operation of the primary IP terminal 20 for shifting from the incoming-call state to the outgoing call prohibited state and to the state in which the secondary IP terminal is currently calling.

In FIG. 7, following S2100, the primary IP terminal 20 in the incoming-call state waits for reception of a response packet from the secondary IP terminals 30 (31 to 34). When a response packet is not received, the other process is performed (no at S2110).

As well as for the packet reception process, the process for determining whether a response packet is received is performed in the following manner.

The LAN-IF unit 301 receives a response packet, and the IP packet processor 302 extracts data from the received response packet, and outputs the data to the telephone controller 309 (see S1040 in FIG. 6). For example, assume that the primary IP terminal 20 receives a packet at S1010. At this time, the destination address of the received packet is (IP: 12.34.56.02) of the primary IP terminal 20, and the transmission source information is (IP: 12.34.56.05) of the secondary IP terminal 31. Thus, the telephone controller 309 of the primary IP terminal 20 determines that the response packet is received from the secondary IP terminal 31 (yes at S2110).

When the response packet is received, the telephone controller 309 of the primary IP terminal 20 extracts the IP address of the PBX 2 from the telephone data memory 308 (S2120).

The telephone controller 309 transmits an instruction to the IP packet processor 302 to change the transmission destination address of the response packet from (IP: 12.34.56.02) of the primary IP terminal 20 to IP address (IP: 12.34.56.01) of the PBX 2 that has been extracted (S2130). That is, a substituted response command is generated.

Thereafter, a substituted response command packet is transmitted from the LAN-IF unit 301 via the IP network N to the PBX 2 (S2140; see S1040 in FIG. 6).

The primary IP terminal 20 examines the transmission source address (IP: 12.34.56.05) of the response packet at S2110, and finds that the secondary IP terminal 31 transmitted the response relative to the incoming-call start. Thus, the telephone controller 309 of the primary IP terminal 20 stores, in the telephone data memory 308, information that the secondary IP terminal 31 has been shifted to the calling state (see S3350 in FIG. 8).

The telephone controller 309 of the primary IP terminal 20 extracts, from the telephone data memory 308, the IP addresses of the other secondary IP terminals 30 (specifically, the secondary IP terminals 32 to 34) (S2150).

The telephone controller 309 transmits an instruction to the IP packet processor 302 to designate the extracted IP addresses as the transmission destination addresses for an outgoing call prohibition packet (S2160).

Then, the outgoing call prohibition packet is transmitted from the LAN-IF unit 301 to the secondary IP terminals 32, 33 and 34 via the IP network N (S2170; see S1050 in FIG. 6).

The telephone controller 309 determines whether the outgoing call prohibition packet has been transmitted to the IP addresses of all the other secondary IP terminals 30 (specifically, the secondary IP terminals 32 to 34) that were extracted at S2150) (S2180). When the outgoing call prohibition packet is not yet transmitted to all the other secondary IP terminals 32 to 34, the processing beginning at S2150 is repeated (no at S2180).

When the outgoing call prohibition packet has been transmitted to all the other secondary IP terminals 32 to 34, the telephone controller 309 of the primary IP terminal 20 halts ringing through the loudspeakers 305 (S2190). Thereafter, the telephone controller 309 displays a message on the display unit 307, representing that outgoing call is prohibited (S2200).

When the telephone controller 309 of the primary IP terminal 20 has transmitted the outgoing call prohibition command, the telephone controller 309 displays an outgoing call prohibition message on the own terminal apparatus, and thereafter, the incoming-call state is shifted to the outgoing call prohibited state (S2300). After the terminal apparatus has issued the outgoing call prohibition command, the terminal apparatus can halt an incoming-call notification. Therefore, redundant outgoing call or receiving of calls at the terminal apparatuses can be prevented. This method is effective when the primary IP terminal 20 is installed in the office and the secondary IP terminal 31 is installed at home.

The secondary IP terminal 31 that transmitted the response command (S3330) is shifted to the calling state (S3350), while the other secondary IP terminals 32 to 34 are shifted to the outgoing call prohibited state (S4030). In this manner, one of the other terminal apparatuses can send a response relative to an incoming call. Thus, the limited number of extension numbers can be more efficiently allocated.

Through this processing, at S2140 in FIG. 7, the substituted response command is transmitted from the primary IP terminal 20 to the PBX 2. Further, referring again to FIG. 6 for the operation of the IP communication system 1, the substituted response command is as indicated at S1040. In addition, the PBX 2 transmits the response packet, via the IP network N to the transmission source, relative to the call received from outside the IP communication system 1 (S1060).

At S2170 in FIG. 7, the primary IP terminal 20 transmits an outgoing call prohibition packet to the secondary IP terminals 32 to 34. Referring to FIG. 6 for the operation of the IP communication system 1, this outgoing call prohibition packet is as indicated at S1050. That is, in FIG. 6, when the primary IP terminal 20 receives a response command from the secondary IP terminal 31, the primary IP terminal 20 transmits a substituted response command to the PBX 2 (S1040), and also transmits an outgoing call prohibition packet to the other secondary IP terminals 32 to 334 (S1050).

And after the outgoing call prohibition command is transmitted, the terminal apparatus halts an incoming call notification, and displays a message indicating outgoing call is prohibited. Therefore, redundant outgoing call or receiving of calls at the terminal apparatuses can be prevented.

As a result, the user (or users) of the primary IP terminal 20 or the secondary IP terminals 32 to 34 need only see the corresponding display unit 307 so that, for example, the use of the primary IP-terminal 20 is disabled because the secondary IP terminal 31 is currently in the calling state. Therefore, the limited number of extension numbers can be effectively allocated, and redundant outgoing call by a plurality of terminal apparatuses can be prevented.

[Outgoing Call Prohibit]

A description has been given for the operation performed by the primary IP terminal 20 that received a call and the secondary IP terminal 31 that responded to the call. Next, a description will be given for the operation performed by the secondary IP terminals 32 to 34 that did not respond to any call and are prohibited to perform outgoing call. For this explanation, as well as for the above explanation, the secondary IP terminal 31, which responded to the incoming call and is currently in the calling state, and only one other secondary IP terminal 32 are employed. This is because the other secondary IP terminals 33 and 34 perform the same operation as the secondary IP terminal 32.

Assume that, as previously described, the user of the secondary IP terminal 31 raises the handset (see S3030 to S3350). The secondary IP terminal 31 responds to an incoming call notification. On the other hand, after S3030, the secondary IP terminals 32 to 34 do not respond to any incoming calls, and let the time go by.

In FIG. 8, for example, the secondary IP terminal 32 is in the incoming-call state wherein rings are generated through the loudspeakers 305 to notify the user of an incoming call (S3030). The secondary IP terminal 32 determines whether an outgoing call prohibition packet is received from the primary IP terminal 20. When the outgoing call prohibition packet is not received, the other process is performed (S4000; see S1050 in FIG. 6).

Determination for the packet reception at S4000 is performed in this manner. In the secondary IP terminal 32, the LAN-IF unit 301 receives the outgoing call prohibition packet from the primary IP terminal 20 (S4000: see S1050 in FIG. 6). Then, the IP packet processor 302 extracts data from the received packet, and outputs the data to the telephone controller 309. Thereafter, the telephone controller 309 determines that the outgoing call prohibition packet is received from the primary IP terminal 20 (yes at S4000).

The telephone controller 309 of the secondary IP terminal 32 halts ringing through the loudspeakers 305 to halt an incoming call notification (S4010).

Following this, the telephone controller 309 of the secondary IP terminal 32 displays a message on the display unit 307 of the secondary IP terminal 32, indicating that outgoing call is currently prohibited (S4020).

In this manner, the secondary IP terminal 32 is shifted from the incoming-call state to the outgoing call prohibited state (S4030).

As a result, the secondary IP terminal 31 that is set to the off-hook state by the user is shifted to the calling state (S3350), and the other secondary IP terminals 32 and 34 that did not respond to the incoming call are shifted to the outgoing call prohibited state (S4030).

Therefore, when the secondary IP terminals 31 and 32 are located in places at a distance, the user need only see the display unit 307 of the secondary IP terminal 32, so that the user can identify the secondary IP terminal 31 is in the calling state.

Further, in FIG. 8, even when the user attempts to dial by raising the handset of the secondary IP terminal 32 in the outgoing call prohibited state, the secondary IP terminal 32 can not be shifted from the outgoing call prohibited state (S4040 to S4030). This is because, even when the off-hook operation is detected, the telephone controller 309 of the secondary IP terminal 32, which was shifted to the outgoing call prohibited state, prohibits outgoing call (yes at S4040). Further, when the off-hook operation is not detected, the other process is performed (no at S4040).

The secondary IP terminal 32 shifted to the outgoing call prohibited state not only displays an outgoing call prohibition message on the display unit 307, but also prohibits packet transmission when the user raises the handset without being aware of the message. Therefore, useless transmission of a packet to the IP network N can be prevented. Thus, the limited quantity of extension numbers can be efficiently allocated, and redundant sending or receiving of calls by a plurality of terminal apparatuses can be prevented.

Further, when the user has picked up (raised) the handset in the outgoing call prohibited state, the telephone controller 309 may release an audio guidance from the speaker 305 to the user, indicating outgoing call is prohibited.

With this arrangement, except for a terminal apparatus that is a transmission source of a response command, the other terminal apparatuses receive an outgoing call prohibition packet, halt an incoming call notification, and display a message to indicate outgoing call is currently prohibited. Furthermore, when the off-hook operation is detected, outgoing call is also prohibited. Therefore, the limited quantity of extension numbers can be efficiently allocated, and redundant sending and receiving calls by a plurality of terminal apparatuses can be prevented.

[Communication Relay Processing]

A description will now be given for the operation of the primary IP terminal 20 performed when the primary IP terminal 20 is in the outgoing call prohibited state and the secondary IP terminal 31 is in the calling state. FIG. 9 is a flowchart for explaining the outgoing call prohibited state of the primary IP terminal 20.

Assume that, in FIG. 9, as well as in FIG. 7, the primary IP terminal 20 is in the outgoing call prohibited state (S2300) and the secondary IP terminal 31 is in the calling state (S3350).

When the primary IP terminal 20 is in the “outgoing call prohibited/secondary IP terminal currently calling” state at S2300, the LAN-IP unit 301 of the primary IP terminal 20 receives a packet. The IP packet processor 302 extracts data from the received packet, and outputs the data to the telephone controller 309 (see S1080 in FIG. 6). For example, when the packet at S1080 is received by the primary IP terminal 20, the destination address of this packet is (IP:12.34.56.02) for the primary IP terminal 20, and the transmission source address is (IP:12.34.56.01) for the PBX 2. Based on the data of the received packet, it is found that the received packet is a voice communication packet. Through this process, the telephone controller 309 determines whether a voice communication packet is received from the PBX 2 (S2400).

When it is determined that a voice communication packet is received (yes at S2400), the telephone controller 309 of the primary IP terminal 20 extracts the IP address of the secondary IP terminal 31 in the calling state that was previously stored in the telephone data memory 308 (S2410; see S2140 in FIG. 7).

The telephone controller 309 designates the transmission destination address of the communication speech packet as the IP address of the secondary IP terminal 31, and designates the transmission source address of the communication speech packet as the IP address of the primary IP terminal 20 (S2420). And the voice communication packet, for which the address setup has been performed, is transmitted to the secondary IP terminal 31 in the calling state (S2430; see S1090 in FIG. 6), and the primary IP terminal 20 is returned to the outgoing call prohibited state (S2300).

In this manner, the voice communication packet issued by the transmission source is sequentially transmitted from the IP network N to the PBX 2 (see S1070 in FIG. 6), then from the PBX 2 to the primary IP terminal 20 (see S1080 in FIG. 6), and from the primary IP terminal 20 to the secondary IP terminal 31 (see S1090 in FIG. 6).

Referring again in FIG. 9, when a voice communication packet is not received from the PBX 2 at S2400 (no at S2400), a check is performed to determine whether a voice communication packet is received from the secondary IP terminal 31 in the calling state (S2500; see S1100 in FIG. 6).

When, as well as at S2400, it is determined that a voice communication packet is received from the secondary IP terminal 31 in the calling state (yes at S2500), the IP address of the PBX 2 is extracted from the telephone data memory 308 (S2510).

In the same manner as at S2420, the telephone controller 309 designates the transmission destination address of the voice communication packet as the IP address of the PBX 2, and designates the transmission source address of the voice communication packet as the IP address of the primary IP terminal 20 (S2520). Then, the voice communication packet, for which the address setup is completed, is transmitted to the PBX 2 (S2530; see S1110 in FIG. 6). After the packet is transmitted, the primary IP terminal 20 is returned to the outgoing call prohibited state (S2300).

Through this processing, as shown in FIG. 6, the voice communication packet prepared by the secondary IP terminal 31 is sequentially transmitted from the secondary IP terminal 31 to the primary IP terminal 20 (see S1100 in FIG. 6), then from the primary IP terminal 20 to the PBX 2 (see S1110 in FIG. 6), and from the PBX 2 to the IP network N (see S1120 in FIG. 6).

Referring again in FIG. 9, when a voice communication packet is not received from the secondary IP terminal 31 in the calling state at S2500 (no at S2500), a check is performed to determine whether a packet is received from the secondary IP terminals 32 to 34 other than the secondary IP terminal 31 in the calling state (S2600).

When a packet is not received from any of the secondary IP terminals 32 to 34 other than the secondary IP terminal 31 in the calling state, the other process is performed (no at S2600).

Further, when a packet is received from one of the secondary IP terminals 32 to 34 (yes at S2600), the primary IP terminal 20 can not accept the packet from any of the secondary IP terminals 32 to 34, because the primary IP terminal 20 is currently calling with the secondary IP terminal 31. Therefore, even when the primary IP terminal 20 receives a packet from the secondary IP terminals 32 to 34 other than the secondary IP terminal 31 in the calling state, the primary IP terminal 20 ignores and abandons the received packet (S2610). After the packet is abandoned, the primary IP terminal 20 is returned to the outgoing call prohibited state (S2300).

As described above, when the primary IP terminal 20 receives a packet from the secondary IP terminals 32 to 34, other than the secondary IP terminal 31 in the calling state, the primary IP terminal 20 ignores and abandons the received packet. Therefore, the limited quantity of extension numbers can be more efficiently allocated, and redundant sending or receiving calls by a plurality of terminal apparatuses can be prevented.

Further, since the IP communication system 1 having the above described functions can be constituted, a conventional IP phone may be employed for the secondary IP terminals 32 to 34, without adversely affecting the secondary IP terminal 31 or the other terminal.

Furthermore, by employing, as a trigger, the reception of a packet from one of the secondary IP terminals 32 to 34 in the calling state, an audio data packet for prohibiting the use of a terminal may be transmitted from the primary IP terminal 20 to the secondary IP terminal 32 to 34 that is a transmission source of the received packet. With this arrangement, even when a conventional IP phone is employed for the secondary IP terminals 32 to 34, the user can be notified of the outgoing call prohibited state.

[Receiving & Sending]

The operation will now be described for a case, as explained while referring to FIG. 8, wherein the secondary IP terminal 31 responded to an incoming call and then was shifted to the calling state. FIGS. 10A and 10B are flowcharts for explaining the operation performed by the secondary IP terminal 31 in the calling state. The flowchart in FIG. 10A shows the operation performed for a case wherein the secondary IP terminal receives a communication voice, while FIG. 10B shows operation performed for a case wherein the secondary IP terminal sends a communication voice.

First, through the same communication as explained at S2010 to S2040 in FIG. 7 (reception of a voice communication packet), the PBX 2 receives via the IP network N a voice communication command indicating the extension number “101” (see S1070 in FIG. 6).

The PBX 2 extracts the IP address of the primary IP terminal 20 that corresponds to the extension number “101”, and generates a voice communication packet to be transmitted to the IP network N. Then, for the transmission destination address of this packet, the PBX 2 generates and transmits a voice communication packet (incoming) that includes the IP address of the primary IP packet 20 (see S1080 in FIG. 6).

Upon receiving the command indicated at S1080, the primary IP terminal 20 identifies the command is a voice communication packet transmitted for the secondary IP terminal 31 in the calling state. The primary IP terminal 20 performs the same process as previously described, and transmits, to the secondary IP terminal 31, a substituted voice communication packet, for which the transmission destination IP address is substituted with the IP address of the secondary IP terminal 31, and the transmission source address is substituted with the IP address of the primary IP terminal 20 (see S1090 in FIG. 6).

Referring to FIG. 10A, the secondary IP terminal 31 in the calling state (S3350) performs the same operation as explained at S3000 to S3020 in FIG. 8 to determine whether a voice communication packet is received from the primary IP terminal 20 (S3400). When a voice communication packet is not received, the other process is performed (no at S3400).

When, at S3400, the telephone controller 309 of the secondary IP terminal 31 determines that a voice communication packet is received (yes at S3400), the telephone controller 309 transmits an instruction to the voice encoding unit 303 to convert the voice communication packet into an audio signal for an incoming voice, so that the incoming voice is released through the loudspeakers (S3410; see S1090 in FIG. 6). After the incoming voice is reproduced, the secondary IP terminal 31 is returned to the calling state (S3350).

Through this processing, the secondary IP terminal 31 can reproduce an incoming voice based on a voice communication packet that is received from the primary IP terminal 20.

Further, referring to FIG. 10B, the secondary IP terminal 31 in the calling state (S3350) determines whether there is an ongoing voice signal (S3430). For this determination, the secondary IP terminal 31 prepares an audio signal by picking up the voice of the user through the microphone 304, and outputs the audio signal to the voice encoding unit 303 and the telephone controller 309. The voice encoding unit 303 converts the audio signal into audio data, while the telephone controller 309 receives the audio signal, and determines that the audio signal to be transmitted from the secondary IP terminal 31 is generated (yes at S3430). On the other hand, when a voice is not picked up through the microphone 304, the telephone controller 309 ascertains that there is no ongoing voice, and performs the other process (no at S3430).

When it is determined there is an ongoing voice signal, the telephone controller 309 permits the IP packet processor 302 to change the ongoing voice signal into a transmission packet that is compatible with the IP network N (S3440). That is, voice communication data that represents an ongoing voice is obtained.

The telephone controller 309 extracts the IP address of the primary IP terminal 20 from the telephone data memory 308 (S3450), and designates this IP address as the transmission destination address of a voice communication packet (S3460). Further, the telephone controller 309 extracts the IP address of the secondary IP terminal 31 from the telephone data controller 308, and designates this IP address as the transmission source address of the voice communication packet (S3460). Then, the voice communication packet is transmitted to the primary IP terminal 20 via the LAN-IF unit 301 (S3470; see S1100 in FIG. 6).

After the packet for an ongoing voice has been transmitted to the primary IP terminal 20, the secondary IP terminal 31 is returned to the calling state (S3350). Hereinafter, the inverted processing of the process as explained at S1070 to S1090 is performed, and data for the voice of the user is transmitted from the secondary IP terminal 31, via the primary IP terminal 20 and the PBX 2, to the IP network N (see S1100 to S1120 in FIG. 6).

As a result, the voice communication packet can be transmitted from the secondary IP terminal 31 in the calling state to the primary IP terminal 20.

[Termination of Communication and Waiting State]

Next, the operation for shifting from the calling state to the call waiting state will now be described. FIGS. 11A and 11B are flowcharts showing the processing for shifting the secondary IP terminal from the calling state to the call waiting state. That is, the flowchart in FIG. 11A shows the operation in which the secondary IP terminal 31 in the calling state terminates communication, while the flowchart in FIG. 11B shows the operation in which the other secondary IP terminal 32 in the outgoing call prohibited state is returned to the call waiting state. FIG. 12 is a flowchart showing the processing for shifting the primary IP terminal from the outgoing call prohibited state to the call waiting state.

Assume that the user of the secondary IP terminal 31 has finished a call and put back the receiver (handset) (on-hook state). In FIG. 11A, the telephone controller 309 is monitoring the secondary IP terminal 31 in the calling state (S3350) to determine whether the on-hook state is established (S3510). When the telephone controller 309 determines the on-hook state is not net established, the other process is performed (no at S3510). When the user has finished a call and put back the handset, the telephone controller 309 determines the on-hook state is established (yes at S3510), i.e., the communication is disconnected (see S1130 in FIG. 6).

When the telephone controller 309 determines the on-hook state is established, the telephone controller 309 extracts the IP address of the primary IP terminal 20 from the telephone data memory 308 (S3520). The telephone controller 309 transmits an instruction to the IP packet processor 302 to generate a disconnection packet that includes the extracted IP address of the primary IP terminal 20 as a transmission destination address (S3530).

Then, the disconnection packet, i.e., a disconnection command, is transmitted to the primary IP terminal 20 (S3540). After the disconnection packet has been transmitted to the primary IP terminal 20, the secondary IP terminal 31 is returned from the calling state to the call waiting state (S3000).

Through this processing, when a call is ended (on-hook), the secondary IP terminal 31 can transmit a disconnection packet to the primary IP terminal 20 (see S1130 in FIG. 6).

Sequentially, the operation of the primary IP terminal 20 performed upon receiving a disconnection command will be described. Referring to FIG. 12, the primary IP terminal 20 is in the outgoing call prohibited state because the secondary IP terminal 31 is in the calling state (S2300; see S2300 in FIG. 9). At this time, the primary IP terminal 20 is monitoring the secondary IP terminal 31 in the calling state to determine whether a disconnection command is received from the secondary IP terminal 31 (S2700). When a disconnection command (disconnection packet) is not received, the primary IP terminal 20 performs the other process (no at S2700).

Then, the primary IP terminal 20 examines the transmission source address (IP: 12.34.56.05) of the packet received at S2700, and identifies the secondary IP terminal 31 that transmitted the disconnection packet. Therefore, the telephone controller 309 deletes, from the telephone data memory 308, data indicating that the secondary IP terminal 31 is in the calling state (yes at S2700; see S2110 in FIG. 7).

Following this, the telephone controller 309 of the primary IP terminal 20 extracts the IP address of the PBX 2 from the telephone data memory 308 (S2710).

Sequentially, the telephone controller 309 transmits an instruction to the IP packet processor 302 to designate the IP address of the PBX 2 as the transmission destination address of the disconnection packet (S2720). That is, a substituted disconnection command is generated. The telephone controller 309 transmits the substituted disconnection command to the PBX 2 (S2730; see S1140 in FIG. 6).

Thereafter, the disconnection command issued by the secondary IP terminal 31 is changed into a substituted disconnection command by the primary IP terminal 20, and the substituted disconnection command is transmitted to the PBX 2 (see S1140 in FIG. 6), and then from the PBX 2 to the IP network N (see S1150 in FIG. 6).

Then, the primary. IP terminal 20 extracts, from the telephone data memory 308, the IP addresses of the secondary IP terminals 30 (specifically, the secondary IP terminals 32 to 34) other than the IP terminal 31 that issued the disconnection command (S2740).

The telephone controller 309 of the primary IP terminal 20 transmits an instruction to the IP packet processor 302 to designate the IP addresses of the other secondary IP terminals 32 as the transmission destination addresses for a packet that cancels outgoing call prohibition (S2750). That is, a packet that cancels outgoing call prohibition, i.e., a outgoing call prohibition cancellation command is generated.

Following this, the primary IP terminal 20 transmits the outgoing call prohibition cancellation command via the LAN-IF unit 301 and the IP network N to the other secondary IP terminals 32 (S2760; see S1160 in FIG. 6).

The telephone controller 309 determines whether a packet for canceling outgoing call prohibition has been transmitted to the IP addresses of all the other secondary IP terminals 30 (specifically, the secondary IP terminals 32 to 34) that were extracted at S2740 (S2770). When the packet is not yet transmitted to all the IP terminals 32 to 34, the process beginning at S2740 is repeated (no at S2770).

When the outgoing call prohibition cancellation command has been transmitted to all the secondary IP terminals 32 to 34 (yes at S2770), the telephone controller 309 removes, from the display unit 307 of the primary IP terminal 20, a message indicating outgoing call is currently prohibited (S2780). Then, the primary IP terminal 20 is shifted from the outgoing call prohibited state to the call waiting state (S2000; see S2000 in FIG. 7).

Next, an explanation will be given for the operation in which, upon detecting that the on-hook state of the secondary IP terminal 31 is established, the secondary IP terminals 32 to 34 are to be shifted from the outgoing call prohibited state to the call waiting state. Assume that, in FIG. 11B, the on-hook state of the secondary IP terminal 31 is established. At this time, the secondary IP terminals 32 to 34 are still in the outgoing call prohibited state (S4030). In the following description, as well as in the previous explanations, the secondary IP terminal 32 is employed as an typical example of the secondary IP terminals 32 to 34.

As previously described, since the on-hook operation has been performed for the secondary IP terminal 31, the primary IP terminal 20 transmits an outgoing call prohibition cancellation command to the other secondary IP terminals 32 to 34 (see S1160 in FIG. 6 and S2760 in FIG. 12). At this time, the secondary IP terminal 32 performs a check to determine whether an outgoing call prohibition cancellation packet is received by the LAN-IF unit 301 (S4070). When the outgoing call prohibition cancellation packet is not received, the other process is performed (no at S4070).

When the outgoing call prohibition cancellation packet is received by the LAN-IF unit 301 of the secondary IP terminal 32, the telephone controller 309 employs the IP packet processor 302 to identify that this packet is an outgoing call prohibition cancellation command (yes at S4070):

The telephone controller 309 of the secondary IP terminal 32 deletes, from the display unit 307, a message indicating that outgoing call is prohibited (S4080). Further, the telephone controller 309 allows the input operation at the input unit 306 so as to enable data transmission/reception via the LAN-IF unit 301. Then, the secondary IP terminal 32 is returned to the call waiting state (S3000).

As described above, even when the secondary IP terminal 32 is located at a far distance from the secondary IP terminal 31, a packet for canceling outgoing call prohibition is received from the primary IP terminal 20. Therefore, the secondary IP terminal 32 can be returned to the call waiting state, and the user thereof can identify that the IP terminal 32 is currently in the call waiting state only by checking on the display unit 307.

Through this processing, not only the primary IP terminal 20, but also one of the secondary IP terminals 31 to 34 can be employed to transmit a response relative to an incoming call. Furthermore, an outgoing call prohibition command can be transmitted to the secondary IP terminal 32 to 34, other than the secondary IP terminal (i.e., the secondary IP terminal 31 that received a call) that is the transmission source of the response command, and notifying for an incoming call can be halted. Further, notifying for an incoming call to the own terminal apparatus (primary IP terminal 20) can also be halted.

When the secondary IP terminal 31 that received a call terminates communication, the terminal apparatus (primary IP terminal 20) transmits an outgoing call prohibition cancellation command, so that the other secondary IP terminals 32 to 34 can be returned to the call waiting state. At this time, not only the secondary IP terminal 31 but also the primary IP terminal 20 can also be returned to the call waiting state. Therefore, the limited number of extension numbers can be effectively allocated, and redundant outgoing call and receiving of calls by a plurality of terminal apparatuses can be prevented.

In addition, when a general-purpose computer executes the computer program (software) of this invention, the computer can provide the functions of the IP software phone (the terminal apparatus of the invention).

Through the above described control processing of the invention, when a terminal apparatus receives, from the PBX, an incoming command that includes, as destination information, address information of the terminal apparatus, the terminal apparatus can notify the own user that the received call is addressed to the terminal apparatus. Further, the terminal apparatus generates a substituted incoming command based on data in the memory, and transmits the substituted incoming command to the other multiple terminal apparatuses. Thus, the other terminal apparatuses that receive the substituted incoming command can also notify their users that there is an incoming call.

Therefore, even when only one extension number is allocated to terminal apparatuses, a specific terminal apparatus can notify the other terminal apparatuses of the arrival of a call by transmitting a packet to the other terminal apparatuses. Further, even when the other terminal apparatuses are moved to a place accessible to the IP network, these apparatuses can receive a packet from the PBX via the specific terminal apparatus of the invention. Therefore, the limited number of extension numbers can be effectively allocated.

[Outgoing Call Operation]

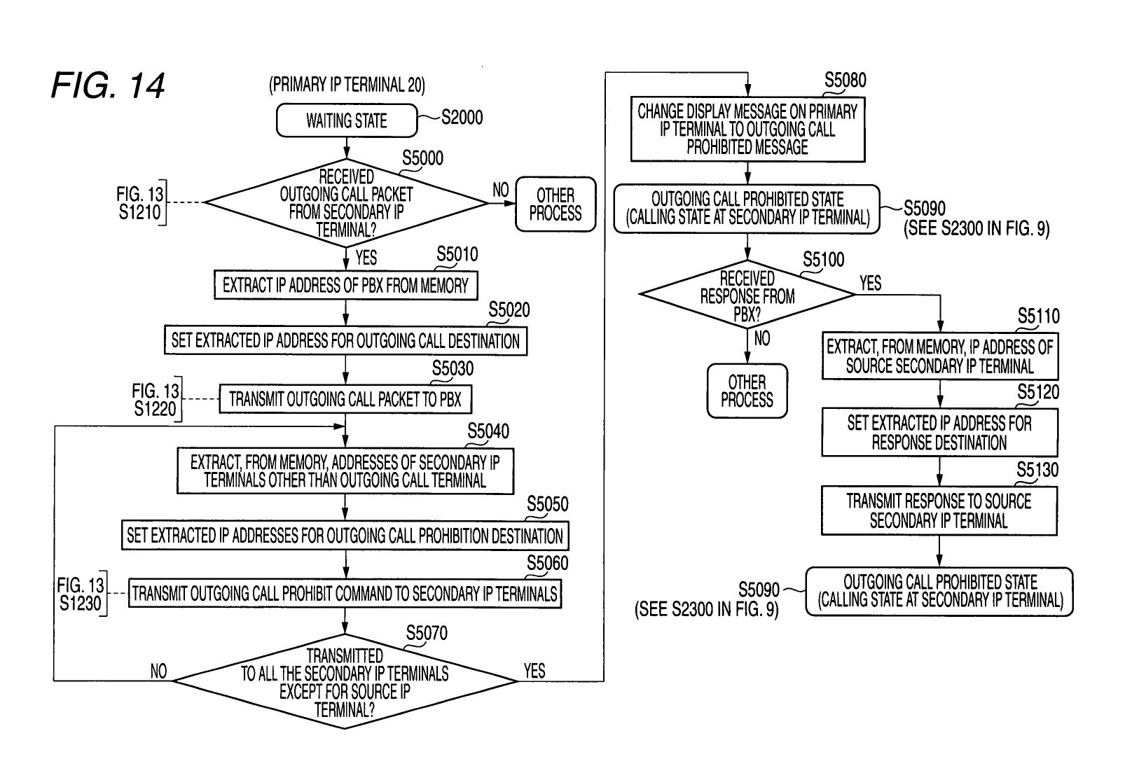

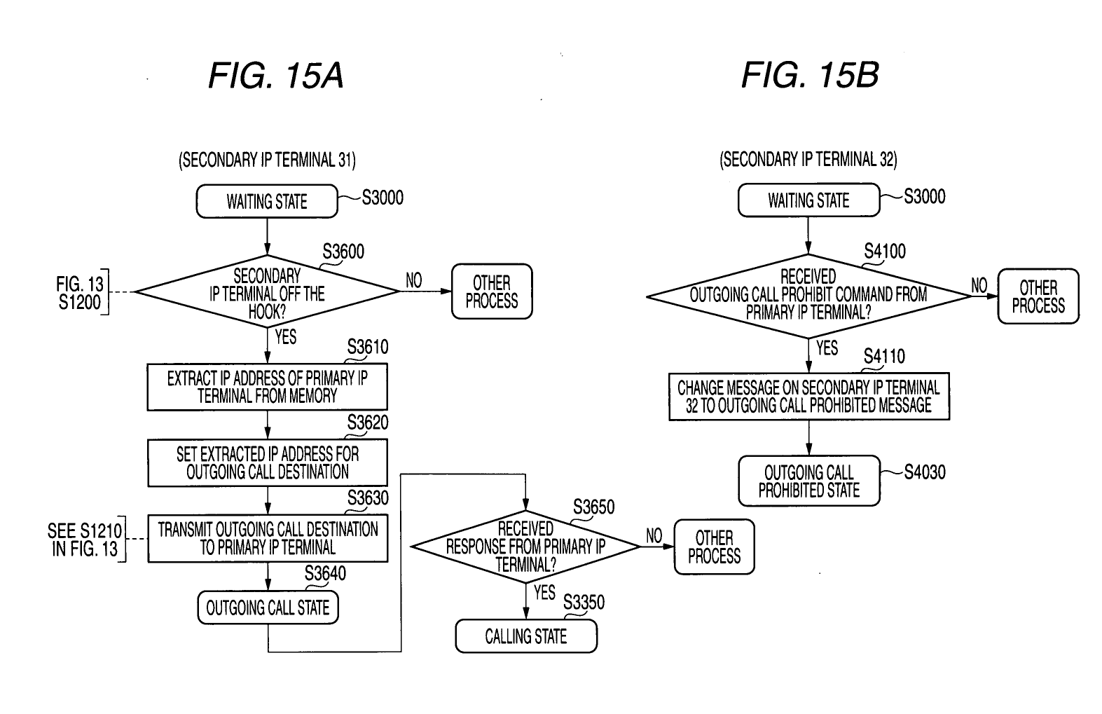

Next, the outgoing call operation of the IP communication system of this embodiment will be described. FIG. 13 is a diagram for explaining the outgoing call operation of the IP communication system. FIG. 14 is a flowchart showing the processing in which the primary IP terminal 20 is shifted from the call waiting state to the outgoing call prohibited state. FIGS. 15A and 15B are flowcharts showing the processing for shifting the secondary IP terminal from the call waiting state to the outgoing call state, to the calling state and to the outgoing call prohibited state. The operation in FIG. 15A is performed for a case wherein one secondary IP terminal establishes communication by outgoing call, and the operation in FIG. 15B is performed for a case wherein outgoing call is prohibited for the other IP terminals.

As well as in the above described reception operation, of the system shown in FIG. 1, the user employs the secondary IP terminal 31 to perform the outgoing call operation, and the other secondary IP terminals 32 to 34 are in the call waiting state. Also, the primary IP terminal 20 and the secondary IP terminals 30 (31 to 34) have the arrangement and the address setup data, as explained while referring to FIGS. 2 to 5. Therefore, for the outgoing call operation performed via the IP network N, the functions of the individual components are the same as those as explained while referring to FIG. 2, and no further explanation for them will be given.

In FIGS. 13, 14 and 15, the secondary IP terminal 31 is in the call waiting state (see S3000 in FIG. 15), and the user performs the off-hook operation for the secondary IP terminal 31 (see S1200 in FIG. 13; yes at S3600 in FIG. 15). When the off-hook state is not detected, the telephone controller 309 performs the other process (no at S3600 in FIG. 15)

When the telephone controller 309 of the secondary IP terminal 31 detects the off-hook state (yes at S3600 in FIG. 15), the telephone controller 309 extracts the IP address of the primary IP terminal 20 from the telephone data memory 308 (S3610).

At this time, like in the process explained at S3310 to S3330 in FIG. 8, the telephone controller 309 extracts the IP address of the primary IP terminal 20 as the IP address of a connection destination for the PBX 2. Therefore, the telephone controller 309 of the secondary IP terminal 31 is regarded as an extension terminal connected to the PBX 2, and behaves as the secondary IP terminal 31 correlated with the primary IP terminal 20.

The telephone controller 309 transmits an instruction to the IP packet processor 302 to designate the extracted IP address of the primary IP terminal 20 as the outgoing call destination address for a packet for outgoing call (outgoing call command) (S3620).

Thereafter, the telephone controller 309 transmits, to the primary IP terminal 20 as a destination, the outgoing call packet indicating that a communication is to be started by the off-hook operation (see S1210 in FIG. 13 and S3630 in FIG. 15). After the outgoing call command is transmitted, the secondary IP terminal 31 is shifted from the call waiting state to the outgoing call state (S3640).

[Substituted Outgoing Call Command]

The operation of the primary IP terminal 20 performed upon receiving an outgoing call command will now be described. In FIG. 14, the primary IP terminal 20 is in the call waiting state (S2000; see S2000 in FIG. 7 and S2000 in FIG. 12).

The telephone controller 309 of the primary IP terminal 20 waits for reception of an outgoing call packet. For example, through the same process as explained at S2110 in FIG. 7, the LAN-IF unit 301 receives an outgoing call packet, and the IP packet processor 302 extracts data from the outgoing call packet and outputs the data to the telephone controller 309. At this time, the transmission destination address of the received outgoing call packet is (IP: 12.34.56.02) of the primary IP terminal 20, and the transmission source information is (IP: 12.34.56.05) of the secondary IP terminal 31.

Then, the telephone controller 309 of the primary IP terminal 20 determines an outgoing call packet is received from the secondary IP terminal 31 (yes at S5000). When an outgoing call packet is not received from the secondary IP terminal 31, the other process is performed (no at S5000).

Upon receiving the outgoing call command, the telephone controller 309 of the primary IP terminal 20 extracts the IP address of the PBX 2 from the telephone data memory 308 (S5010).

Following this, the telephone controller 309 transmits an instruction to the IP packet processor 302 to designate the extracted IP address (IP: 12.34.56.01) of the PBX 2 as the transmission destination address of the outgoing call packet (S5020). That is, a substituted outgoing call command is generated (see S1220 in FIG. 13). Thereafter, the telephone controller 309 transmits the packet of the substituted outgoing call command from the LAN-IF unit 301 via the IP network N to the PBX 2 (S5030). Also, the telephone controller 309 of the primary IP terminal 20 stores, in the telephone data memory 308, the IP address of the secondary IP terminal 31 from which the outgoing call packet was received.

Upon receiving the substituted outgoing call command, the PBX 2 transfers an outgoing call packet via the IP network N to the terminal where the call was received (see S1240 in FIG. 13).

As described above, since based on the outgoing call packet, the telephone controller 309 of the primary IP terminal 20 identifies the secondary IP terminal 31 performs the outgoing call operation, the telephone controller 309 extracts the IP address of the other secondary IP terminal 32 (and 33 and 34) from the telephone data memory 308 (S5040).

The telephone controller 309 of the primary IP terminal 20 transmits an instruction to the IP packet processor 302 to designate the extracted IP address of the IP terminal 32 (and 33 and 34) as transmission destination address for an outgoing call prohibition packet (S5050).

Then, the telephone controller 309 sequentially transmits the outgoing call prohibition packet from the LAN-IF unit 301 via the IP network N to the target secondary IP terminal 32 (and 33 and 34) (see S1230 in FIG. 13 and S5060 in FIG. 14). That is, an outgoing call prohibition command is transmitted.

The telephone controller 309 performs a check to determine whether the outgoing call prohibition command has been transmitted to the IP addresses of all the secondary IP terminals (32 to 34) stored in the telephone data memory 308, except for the secondary IP terminal 31 that is currently in the outgoing call state. When the outgoing call prohibition command is not yet transmitted to all the secondary IP terminals, the processing beginning at S5040 is repeated (S5070).

Sequentially, the telephone controller 309 of the primary IP terminal 20 displays a message on the display unit 307, indicating that outgoing call is prohibited (S5080). Then, the primary IP terminal 20 is shifted from the call waiting state to the outgoing call prohibited state (S5090; see S2300 in FIG. 9).

In this manner, the substituted outgoing call command is transmitted from the primary IP terminal 20 to the PBX 2, and then from the PBX 2 to the IP network N (see S1220 and S1240 in FIG. 13). Also, an outgoing call prohibition command is transmitted from the primary IP terminal 20 to the secondary IP terminals 32 to 34 (see S1230 in FIG. 13).

Referring to FIG. 15B, the secondary IP terminals 32 to 34, as well as in the secondary IP terminal 31, are in the call waiting state (S3000). The telephone controllers 309 of the secondary IP terminals 32 to 34 monitor the LAN-IF units 301 to determine whether a packet is received.

Since the above described outgoing call prohibition command is transmitted from the primary IP terminal 20 to each of the secondary IP terminals 32 to 34, the LAN-IF unit 301 of the secondary IP terminal 32 receives this packet, and the IP packet processor 302 extracts data from the outgoing call prohibition packet, and outputs the data to the telephone controller 309 (S4100).

Thus, the secondary IP terminal 32 determines that the outgoing call prohibition packet is received (yes at S4100). When an outgoing call prohibition packet is not received, the other process is performed (no at S4100).

Sequentially, the telephone controller 309 of the secondary IP terminal 32 displays a message on the display unit 307, indicating outgoing call is prohibited (S4110). Thereafter, the secondary IP terminal 32 is shifted from the call waiting state to the outgoing call prohibited state (S4030; see S4030 in FIG. 8). The secondary IP terminals 33 and 34 also perform the processes at S4100, S4110 and S4030 (see S4030 in FIG. 8), and thereafter are shifted to the outgoing call prohibited state.

The secondary IP terminal 31 is currently in the outgoing call state with the handset being off the hook (S3640). The user then enters phone numbers, e.g., manipulates keys “81921234567” at the input unit 306. The telephone controller 309 of the secondary IP terminal 31 permits the packet processor 302 to generate packets for key entries of “8”, “1”, . . . and “7”. Then, the telephone controller 309 of the secondary IP terminal 31 sequentially transmits the individual packets of the key entry data to the primary IP terminal 20 via the LAN-IF unit 301.

The primary IP terminal 20 performs the same process (see S5010 to S5030) as for the above described substituted outgoing call command, and transmits, to the PBX 2, the key entry data packets received from the secondary IP terminal 31. The PBX 2 processes the key entry data packets received from the primary IP terminal 20, and reproduces dial number “81921234567”. The PBX 2 selects a line that matches the dial number, and transmits the dial number. Since the dial number processing and the line selecting processing are not related to the subject of the invention, a detailed technical description for them will not be given.

When a call signal has reached the destination, the user at the destination responds to the call signal through the off-hook operation (see S1250 in FIG. 13). When the user at the destination responds to the call, a response packet is transmitted from the destination via the IP network N to the PBX 2 (see S1260 in FIG. 13).

When the PBX 2 receives a response packet, the PBX 2 processes the contents of the response packet, and transfers the response data to the primary IP terminal 20 that is a transmission destination for the response packet (see S1270 in FIG. 13). At this time, the primary terminal 20 of the IP communication system 1 is in the outgoing call prohibited state (see S5090 in FIG. 14 and S2300 in FIG. 9). Further, the secondary IP terminal 31 that is left off the hook is in the outgoing call state (S3640 in FIG. 15A), while the other secondary IP terminals 32 to 34 are in the outgoing call prohibited state (see S4030 in FIG. 15B).

Referring to FIG. 14, the primary IP terminal 20 in the outgoing call prohibited state is monitoring to determine whether a response packet is received from the PBX 2 (S5100). In the same manner as at S2010 in FIG. 7, the telephone controller 309 of the primary IP terminal 20 determines that a response packet is received from the PBX 2 (yes at S5100). When it is determined that a response packet is not received, the other process is performed (no at S5100).

When the telephone controller 309 of the primary IP terminal 20 determines that a response packet is received from the PBX 2, the telephone controller 309 extracts the IP address of the secondary IP terminal 31 (S5110). This secondary IP terminal 31 is the terminal, for which information that the pertinent secondary IP 31 terminal is the transmission source of an outgoing call packet was stored in the telephone data memory 308 at S5030.

The telephone controller 309 transmits an instruction to the IP packet processor 302 to designate the transmission destination address of the response packet to be the IP address of the secondary IP terminal 31 that is extracted from the telephone data memory 308 (S5120).

Then, the response packet is transmitted from the LAN-IF unit 301 to the IP address of the secondary IP terminal 31 (S5130; S1280 in FIG. 13). That is, a substituted line response command is generated. After the response packet is transmitted, the processing is returned to S5090, and the primary IP terminal 20 continues to display a message on the display unit 307, indicating outgoing call is prohibited.

Through this processing, a response packet is transmitted from the address destination to the PBX 2, from the PBX 2 to the primary IP terminal 20 and then from the primary IP terminal 20 to the secondary IP terminal 31.

In FIG. 15A, the user of the secondary IP terminal 31 who has entered the dial number (S3630) waits for a response from the address destination. That is, the secondary IP terminal 31 waits for reception of a substituted line response command from the primary IP terminal 20 (S3650). When a substituted line response command is not received, the secondary IP terminal 31 performs the other process (no at S3650).

When a substituted line response command (response command from the address destination) is received from the primary IP terminal 20 (yes at S3650), the secondary IP terminal 31 is shifted from the outgoing call state to the calling state (S3350). As a result, the user of the secondary IP terminal 31 starts communication with the address destination. That is, the secondary IP terminal 31 and the address destination can perform communication with each other, with the PBX 2 and the primary IP terminal 20 in between.

At this time, the other secondary IP terminals 32 to 34 are continuously in the outgoing call prohibited state shown in FIG. 15B (S4030). Further, the telephone controller 309 of the primary IP terminal 20 stores, in the telephone data memory 308, information that the secondary IP terminal 31 at the transmission source was shifted to the calling state (see S5130 in FIG. 14).

In FIG. 13, since the process from the start of communication until the disconnection is the same as that explained while referring to FIG. 6, simply the same step numbers (S1070 to S1160) are provided, and no further explanation for it will be given.

More specifically, as for the primary IP terminal 20, since the outgoing call prohibited state (S2300), since the processing for sending and receiving a communication voice (S2400 and S2500) and the process for receiving data from the secondary IP terminals 32 to 34 are the same as those as explained while referring to FIG. 9, no further explanation for them will be given. Also, since the process for disconnecting communication and shifting the primary IP terminal 20 in the outgoing call prohibited state (S2300) to the call waiting state (S2000) is the same as that explained while referring to FIG. 12, a description for this will not be given.

Moreover, after the secondary IP terminal 31 is shifted from the outgoing call state to the calling state (S3350), the operation (transmission/reception of audio data) performed during communication is the same as described while referring to FIG. 10, and the operation performed to terminate the communication is the same as described while referring to FIG. 11A. Therefore, no further explanation for them will be given.

In addition, for the other secondary IP terminals 30 (32 to 34), since the process for shifting from the call waiting state to the outgoing call prohibited state (S4030) and then to the call waiting state is the same as the process described while referring to FIG. 11B, no further description will be given.

As described above, in the outgoing call operation, even when the extension number is allocated only a primary IP terminal 20, an arbitrary secondary IP terminal 31 to 34 can make outgoing call to the IP network N. Even when a desired number of secondary IP terminals 31 to 34 are prepared, the IP addresses of these terminals need simply be designated to the primary IP terminal 20, so that a limited quantity of extension numbers can be effectively allocated.

With this arrangement, only one extension number is allocated to terminal apparatuses, an outgoing call command issued by one of the other terminal apparatuses can be transmitted from a specific terminal apparatus via a PBX. Further, even when the other terminal apparatus is moved to a place accessible to the IP network, a packet can be transmitted to the PBX via a terminal apparatus provided by the present invention.

Furthermore, in an environment wherein the primary IP terminal 20 and the secondary IP terminal 31 are located at a far distance from each other, the user of the primary IP terminal 20 needs only to see the display unit 307 of the terminal 20 to identify that the secondary IP terminal 31 is in the outgoing call state and outgoing call from the primary IP terminal 20 is currently disabled (S5080).

In this manner, an outgoing call prohibition message is displayed not only on the terminal apparatus of the user, but also on the other terminal apparatuses. Therefore, a limited number of extension numbers can be efficiently allocated, and redundant outgoing call by a plurality of terminal apparatuses can be prevented.

In addition, as described above, the outgoing call command includes data, such as audio data and operating data for the other terminal apparatuses to be transmitted to the PBX. Accordingly, the substituted outgoing call command to be transmitted to the PBX can include the audio data and the operating data for the other terminal apparatuses. Therefore, also, the other terminal apparatuses can transmit the operating data or audio data, so that the operation can be instructed, or the voice communication can be released by the other terminal apparatuses.

Further, when a general-purpose computer executes the computer program (software) of this invention, the computer can provide the functions of the IP software phone (the terminal apparatus of the invention).

And when the software of this invention is performed, an outgoing call command that a specific terminal apparatus received from another terminal apparatus can be transmitted via the PBX even if only one extension number is allocated to the terminal apparatuses 3, 30. Further, even when the other terminal apparatus is moved to a place accessible to the IP network, a packet can be transmitted to the PBX via a terminal apparatus provided by the invention. Therefore, a limited number of extension numbers can be efficiently allocated to perform outgoing call.

When the software of the invention is performed, a specific terminal apparatus can display, on its display unit, an outgoing call prohibition message by issuing an outgoing call prohibition command. Thus, redundant outgoing call, or receiving of a call, by the terminal apparatus can be prevented.

### Second Embodiment

[Broadcast]

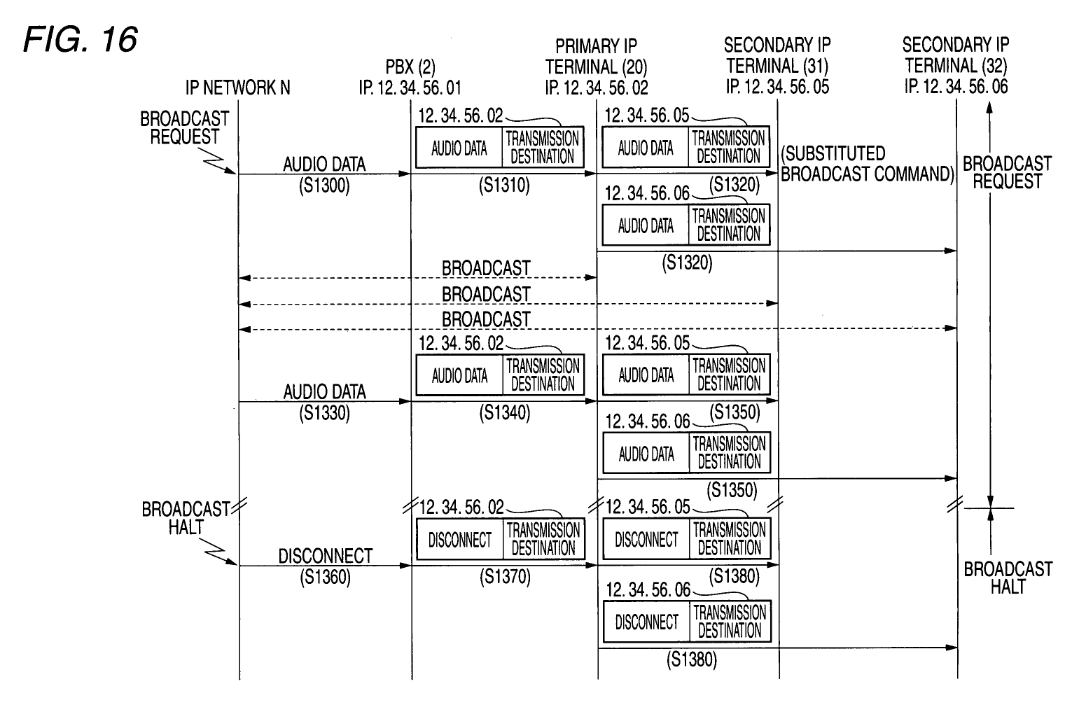

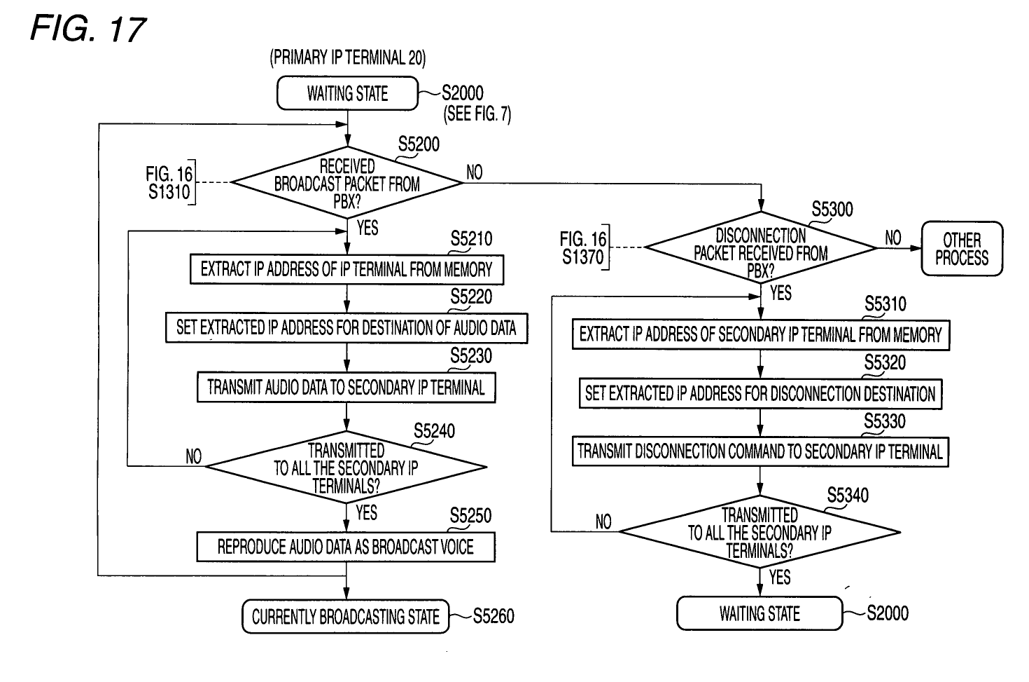

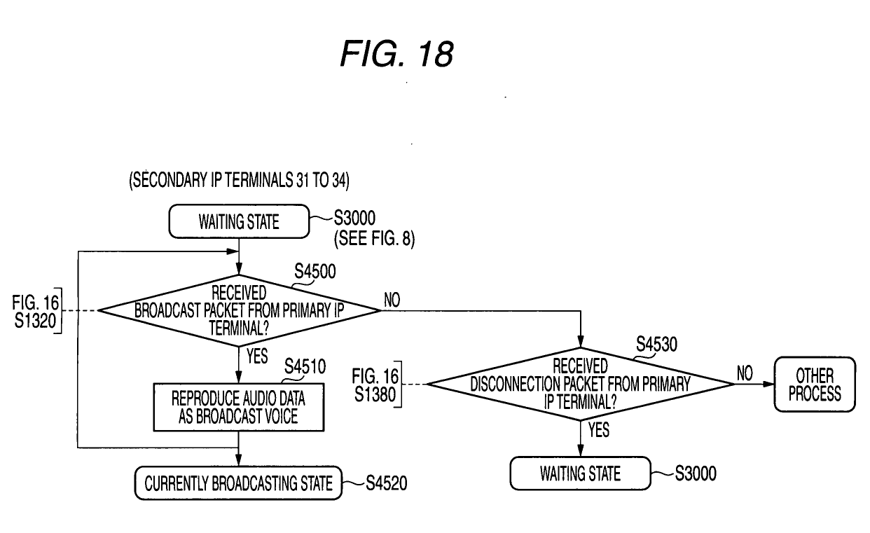

The broadcast operation of an IP communication system according to a second embodiment of the present invention will now be described. FIG. 16 is a diagram for explaining the outgoing call operation of an IP communication system according to this embodiment. FIG. 17 is a flowchart for explaining the operation performed by a primary IP terminal in the broadcasting state, and FIG. 18 is a flowchart for explaining the operation performed by a secondary IP terminal in the broadcasting state.

In the second embodiment, the broadcast operation is a process in which a voice received from a transmission source is output (sounds are generated) through loudspeakers at a destination, even when the off-hook state is not detected at the destination. According to this function, the terminals at the individual destinations can be used like cable broadcasting terminals.

In FIG. 16, as well as in FIG. 6 explained for the first embodiment, of secondary IP terminals 31 to 34, secondary IP terminals 31 and 32 are employed for the description.

In FIG. 16, assume that a primary IP terminal 20 and the secondary IP terminals 31 and 32 are in the waiting state (see S2000 in FIG. 17 and S3000 in FIG. 18). A packet is transmitted from the transmission source via the IP network N to the extension number “101” of a PBX 2 (S1300). This packet is a broadcast request command that indicates broadcast is to start, and includes a notification indicating that broadcast is to start, audio data and information about the extension number of an address destination.

In the same manner as for the operation explained at S1000 to S1010 in FIG. 6, the PBX 2 transmits a broadcast packet to the primary IP terminal 20 that is correlated with the extension number “101” (S1316).

The operation of the primary IP terminal 20 will now be described. In FIG. 17, the primary IP terminal 20 is initially in the waiting state, i.e., waits for reception from the PBX 2 of a packet that includes a notification indicating that broadcast is to start and audio data (S2000). The primary IP terminal 20 monitors the reception of a packet at a LAN-IF unit 301 (S5200). When a packet is not received, the other process is performed (no at S5200).

[Substituted Broadcast Command]

A telephone controller 309 of the primary IP terminal 20 determines that the LAN-IF unit 301 has received a packet indicating that broadcast is to start (yes at S5200; see S1310 in FIG. 16). Since the operation for determining whether a target packet is received is the same as explained at S2010 in FIG. 7, no detailed explanation for this will be given.

The telephone controller 309 of the primary IP terminal 20 extracts, from a telephone data memory 308, the IP addresses of the secondary IP terminals 31 to 34 (S5210).

As in the operation for generating a substituted incoming call command (see S1020 in FIG. 6 and also S2020 to S2050 in FIG. 7), the telephone controller 309 transmits an instruction to an IP packet processor 302 to designate, as the transmission destination address of the audio data packet, the IP address of the secondary IP terminal 31 that is extracted from the telephone data memory 308 (S5220). That is, a substituted broadcast command is generated.

Following this, the telephone controller 309 of the primary IP terminal 20 transmits the substituted broadcast command via the LAN-IF unit 301 to the secondary IP terminal 31 (S5230).

Then, the telephone controller 309 determines whether the substituted broadcast command has been transmitted to the IP addresses of all the secondary IP terminals 31 to 34 stored in the telephone data memory 308. When this command is not yet transmitted to all the IP addresses, the processing is returned to S5210, and the processes at S5210 to S5240 are repeated (S5240).

Sequentially, the telephone controller 309 of the primary IP terminal 20 employs a voice encoding unit 303 to decode the received audio data into an audio signal, and releases the obtained audio signals through loudspeakers 305, regardless of whether the handset of the primary IP terminal 20 is taken off the hook (S5250). Thereafter, the telephone controller 309 of the primary IP terminal 20 is shifted from the waiting state to the currently broadcasting state (see S1320 in FIG. 16 and S5260 in FIG. 17).

Through this processing, the packet of audio data issued by the broadcast source is sequentially transmitted from the PBX 2 to the primary IP terminal 20, and from the primary IP terminal 20 to the secondary IP terminals 31 to 34 (see S1330 to S1350 in FIG. 16).

Next, the operation of the secondary IP terminals 31 to 34 will be described by employing the secondary IP terminal 31. In the same manner as previously described for the broadcast function, a broadcast packet to be transmitted from the PBX 2 to the primary IP terminal 20 is also transmitted to all the secondary IP terminals 31 to 34 associated with the primary IP terminal 20, so that the same audio data are reproduced through the loudspeakers 305 of the individual secondary terminals 31 to 34.

In FIG. 18, the secondary IP terminal 31 is initially in the waiting state (S3000), and waits for reception of a broadcast packet from the primary IP terminal 20 (S4500). When a broadcast packet is not received, the other process is performed (no at S4500).

As well as at S5200 in FIG. 17, the secondary IP terminal 31 determines that a broadcast packet is received from the primary IP terminal 20 (yes at S4500; see S1320 in FIG. 16).

Then, the secondary IP terminal 31 employs the voice encoding unit 303 to decode audio data included in the broadcast packet, and releases the obtained audio signal through the loudspeakers 305, regardless of whether the handset of the secondary IP terminal 31 is taken off the hook (S4510).

Following this, the secondary IP terminal 31 is shifted to the currently broadcasting state (S4520), and waits for reception of a broadcast packet to prepare for the next audio data.

In this manner, the broadcast packet transmitted by the primary IP terminal 20 is reproduced through the loudspeakers 305 of the secondary IP terminal 31. Further, since the primary IP terminal 20 repeats the processing until transmission of the broadcast packet to all the IP addresses of the secondary IP terminals 31 to 34 is completed (see S5210 to S5240 in FIG. 17), the audio data included in the broadcast packet are reproduced through the loudspeakers of all the secondary IP terminals 31 to 34.

Referring to FIG. 16, to terminate the broadcast, the broadcast source transmits, to the PBX 2, a broadcast halt command indicating the broadcast is to be terminated (S1360). The PBX 2 determines a signal for terminating the broadcast, and transmits a disconnection packet to the primary IP terminal 20 (S1370).

In FIG. 17, the primary IP terminal 20 in the currently broadcasting state (S5260) waits for reception of the next packet from the PBX 2 (S5200 and S5300). When the next packet is not received, the other process is performed (no at S5200 and no at 5300).

The primary IP terminal 20 examines a packet that is received, and determines that the received packet is a disconnection packet (yes at S5300; see S1370 in FIG. 16). As in the operation previously explained at S5210 to S5240, the IP addresses of the secondary IP terminals 31 to 34 are extracted from the telephone data memory 308 (S5310).

Sequentially, the telephone controller 309 of the primary IP terminal 20 transmits an instruction to the IP packet processor 302 to designate, as the transmission destination address of the disconnection packet, the IP address of the secondary IP terminal 31 that is extracted from the telephone data memory 308 (S5320).

Then, the telephone controller 309 transmits the disconnection packet via the LAN-IF unit 301 to the IP address of the secondary IP terminal 31 (S5330).

Thereafter, the telephone controller 309 performs a check to determine whether the disconnection packet has been transmitted to the IP addresses of all the secondary IP terminals 31 to 34 (S5340). When the disconnection packet is not yet transmitted to all the secondary IP terminals 31 to 34, the processes at S5310 to 5340 are repeated (no at S5340). When the disconnection packet has been transmitted to all the secondary IP terminals 31 to 34, the telephone controller 309 of the primary IP terminal 20 is shifted to the waiting state (yes at S5340; S2000).

On the other hand, in FIG. 18, the secondary IP terminal 31 in the currently broadcasting state (S4520) waits for reception of the next packet from the primary IP terminal 20 (S4500 and S4530). When the next packet does not arrive, the other process is performed (no at S4500 and no at S4530).

The secondary IP terminal 31 examines a packet that is received, and determines that the received packet is a disconnection packet (yes at S4530; see S1380 in FIG. 16). Then, the secondary IP terminal 31 ascertains that the currently broadcasting state is terminated, and is shifted to the waiting state (S3000).

In this manner, the PBX 2 receives a broadcast halt command from the broadcast source, and transmits a disconnection packet to the primary IP terminal 20. The primary IP terminal 20 receives the disconnection packet, and transfers this disconnection packet to the secondary IP terminals 31 to 34. Therefore, the broadcast halt command is sequentially transferred from the primary IP terminal 20 to the secondary IP terminals 31 to 34 (S1360 to S1380).

As described above, the technique for substituting the IP address of the primary IP terminal with the IP address of a secondary IP terminal can also be applied for broadcasting. Therefore, when a broadcast request command is transmitted from the broadcast source to the extension number “101”, listening to a broadcast is available not only by the primary IP terminal 20 (correlated with the extension number “101”), but also by all of the secondary IP terminals 31 to 34. Further, even when the secondary IP terminals 31 to 34 are located apart from the primary IP terminal 20, listening to a broadcast is available in the individual places.

As described above, when the IP addresses of the secondary IP terminals 31 to 34 are designated in correlation with the primary IP terminal 20, a substituted command can be employed, and even when there is a limitation for the capacity of the PBX 2 to store extension numbers, the extension numbers can be efficiently allocated.

The present invention can provide a terminal apparatus, for which a limited quantity of extension numbers can be allocated efficiently, and a computer-readable medium recording a computer program therefor, and is useful for an IP terminal apparatus that is connected to an IP network.

This application is based upon and claims the benefit of priority of Japanese Patent Application No. 2007-83757 filed on Mar. 28, 2007 and No. 2007-299020 filed on Nov. 19, 2007, the contents of which are incorporated herein by reference in its entirety.

1. A terminal apparatus, comprising:
a communication unit connected to a private branch exchange and other terminal apparatus;
a memory unit for storing address information for the other terminal apparatus; and
a controller which, when receiving an incoming call command containing address information for the terminal apparatus as destination information from the private branch exchange via the communication unit, informs a user of the terminal apparatus of an incoming call addressed to the terminal apparatus, generates a substituted incoming call command in which the address information contained in the incoming call command is substituted with the address information for the other terminal apparatus stored in the memory unit, and transmits the substituted incoming call command to the other terminal apparatus via the communication unit so that the other terminal apparatus informs a user of the other terminal apparatus of the incoming call addressed to the terminal apparatus.

2. The terminal apparatus according to claim 1, wherein address information for the private branch exchange is stored in the memory unit; and
wherein when receiving a response command in response to the substituted incoming-call command via the communication unit from one of a plurality of the other terminal apparatuses, the controller generates a substituted response command in which the address information for the terminal apparatus as destination information of the response command is substituted with the address information for the private branch exchange stored in the memory unit so as to transmit the substituted response command via the communication unit.

3. The terminal apparatus according to claim 2, wherein the controller generates an outgoing call prohibition command containing, as destination information, address information for the other terminal apparatuses other than the one of the other terminal apparatuses serving as a transmission source of the response command based on the memory unit, and transmits the outgoing call prohibition command via the communication unit to the other terminal apparatuses in order to halt the incoming call notification for the other terminal apparatuses.

4. The terminal apparatus according to claim 3, wherein the controller halts the incoming call notification for the terminal apparatus after the controller transmits the outgoing call prohibition command.

5. The terminal apparatus according to claim 1, wherein address information of the private branch exchange is stored in the memory unit;
wherein the controller includes:
a packet processor which extracts a command from a packet received via the communication unit, and/or generates a packet to be transmitted via the communication unit based on a command; and
a terminal controller which controls an operation of the terminal apparatus;
wherein when receiving an incoming-call command containing address information for the terminal apparatus as destination information from the private branch exchange via the packet processor, the terminal controller informs the user of the terminal apparatus of the incoming call addressed to the terminal apparatus, generates a substituted incoming-call command in which the address information contained as destination information in the incoming-call command is substituted with address information for the other terminal apparatus with reference to the memory unit, and transmits the substituted incoming-call command via the packet processor from the communication unit so that the other terminal apparatus informs the user of the other terminal apparatus of the incoming call addressed to the terminal apparatus.

6. The terminal apparatus according to claim 5, wherein when the terminal controller extracts a response command in response to the substituted incoming-call command via the packet processor by taking a off-hook operation from one of a plurality of the other terminal apparatuses, the terminal controller generates a substituted response command in which the address information contained as destination information in the response command is substituted with address information for the private branch exchange with reference to the memory unit, and transmits the substituted response command via the packet processor from the communication unit; and the terminal controller generates an outgoing call prohibition command containing, as destination information, the address information for the terminal apparatuses other than the one of the terminal apparatuses serving as a transmission source of the response command with reference to the memory unit, and transmits the outgoing call prohibition command via the packet processor from the communication unit so that the incoming call notification at the other terminal apparatuses is halted, and the incoming call notification at the terminal apparatus is halted.

7. A terminal apparatus, comprising:
a communication unit connected to a private branch exchange and a plurality of other terminal apparatuses;
a memory unit for storing address information for the private branch exchange and address information for the other terminal apparatuses; and
a controller which, when receiving an outgoing call command containing address information for the terminal apparatus as destination information from one of the other terminal apparatuses via the communication unit, generates a substituted outgoing call command in which the address information of the terminal apparatus as destination information of the outgoing call command is substituted with the address information for the private branch exchange, and transmits the substituted outgoing call command via the communication unit.

8. The terminal apparatus according to claim 7, wherein the outgoing call command includes data having operating data and/or audio data of the one of the other terminal apparatuses to be transmitted to the private branch exchange.

9. The terminal apparatus according to claim 7, wherein the controller generates an outgoing call prohibition command containing, as destination information, address information for the other terminal apparatuses other than the one of the other terminal apparatuses serving as a transmission source of the response command based on the memory unit, and transmits the outgoing call prohibition command via the communication unit so that an outgoing call prohibition message is displayed on the other terminal apparatuses other than the one of the other terminal apparatuses.

10. The terminal apparatus according to claim 9, wherein the controller displays the outgoing call prohibition message on the terminal apparatus after the controller transmits the outgoing prohibition command.

11. The terminal apparatus according to claim 7,
wherein the controller includes:
a packet processor which extracts a command from a packet received via the communication unit, and/or generates a packet to be transmitted via the communication unit based on a command; and
a terminal controller which controls an operation of the terminal apparatus;
wherein when the packet processor extracts an outgoing call command containing address information for the terminal apparatus as destination information from the one of the other terminal apparatuses, the terminal controller generates a substituted outgoing call command in which the address information contained as destination information in the outgoing call command is substituted with address information for the private branch exchange with reference to the memory unit, and transmits the substituted outgoing call command via the packet processor from the communication unit; and the terminal controller generates an outgoing call prohibiting command containing, as destination address information, the address information for the other terminal apparatuses other than the one of the other terminal apparatuses serving as a transmission source of the outgoing call command with reference to the memory unit, and transmits the outgoing call prohibition command via the packet processor from the communication unit so that the outgoing call prohibition message is displayed on the other terminal apparatuses, and that the outgoing call prohibition message is displayed on the terminal apparatus.

12. A computer-readable medium recording a computer program that permits a computer to perform:
communication process which connects to a private branch exchange and other terminal apparatus;
storage process for storing address information for the other terminal apparatus; and
control process which, when receiving an incoming call command containing address information for the terminal apparatus as destination information from the private branch exchange via the communication process, informs a user of the terminal apparatus of an incoming call addressed to the terminal apparatus, generates a substituted incoming call command in which the address information contained in the incoming call command is substituted with the address information for the other terminal apparatus stored in the storage process, and transmits the substituted incoming call command to the other terminal apparatus via the communication process so that the other terminal apparatus informs a user of the other terminal apparatus of the incoming call addressed to the terminal apparatus.

13. The computer-readable medium according to claim 12, wherein address information for the private branch exchange is stored in the storage process; and
wherein when receiving a response command in response to the substituted incoming-call command via the communication process from one of a plurality of the other terminal apparatuses, the controller generates a substituted response command in which the address information for the terminal apparatus as destination information of the response command is substituted with the address information for the private branch exchange stored in the storage process so as to transmit the substituted response command via the communication process.

14. The computer-readable medium according to claim 12, wherein the controller generates an outgoing call prohibition command containing, as destination information, address information for the other terminal apparatuses other than the one of the other terminal apparatuses serving as a transmission source of the response command based on the storage process, and transmits the outgoing call prohibition command via the communication process to the other terminal apparatuses in order to halt the incoming call notification for the other terminal apparatuses.

15. The computer-readable medium according to claim 14, wherein the controller halts the incoming call notification for the terminal apparatus after the controller transmits the outgoing call prohibition command.

16. A computer-readable medium recording a computer program that permits a computer to perform:
communication process which connects to a private branch exchange and a plurality of other terminal apparatuses;
storage process for storing address information for the private branch exchange and address information for the other terminal apparatuses; and
control process which, when receiving an outgoing call command containing address information for the terminal apparatus as destination information from one of the other terminal apparatuses via the communication process, generates a substituted outgoing call command in which the address information of the terminal apparatus as destination information of the outgoing call command is substituted with the address information for the private branch exchange, and transmits the substituted outgoing call command via the communication process.

17. The computer-readable medium according to claim 16, wherein the controller generates an outgoing call prohibition command containing, as destination information, address information for the other terminal apparatuses other than the one of the other terminal apparatuses serving as a transmission source of the response command based on the storage process, and transmits the outgoing call prohibition command via the communication process so that an outgoing call prohibition message is displayed on the other terminal apparatuses other than the one of the other terminal apparatuses.

18. The computer-readable medium according to claim 17, wherein the controller displays the outgoing call prohibition message on the terminal apparatus after the controller transmits the outgoing prohibition command.
